(19) United States
(12) Patent Application Publication
(10) Pub. No.: US 2011/0132197 A1
(43) Pub. Date: Jun. 9, 2011

(54) EXHAUST RECYCLE SYSTEM

(75) Inventors: Bansei Nagase, Tokyo (JP); Hisashi Saito, Tokyo (JP); Masahiro Nakao, Tokyo (JP)

(73) Assignee: HONDA MOTOR CO., LTD., Tokyo (JP)

(21) Appl. No.: 13/059,846

(22) PCT Filed: Aug. 27, 2009
(86) PCT No.: PCT/JP2009/064940

§ 371 Date: Feb. 18, 2011

(30) Foreign Application Priority Data
Aug. 29, 2008 (JP) 2008-222772
Aug. 29, 2008 (JP) 2008-222826

(51) Int. Cl. B01D 53/02

(52) U.S. Cl. 96/111; 96/143; 96/144

(57) ABSTRACT

Provided is an exhaust recycling system, which can burn and remove efficiently a VOC in an exhaust gas discharged from a predetermined zone and which can recycle the clean air after the removal of VOC. Also provided is a technique capable of stabilizing the concentration of the VOC contained in the exhaust gas to be fed to an adsorption apparatus. The exhaust recycling system comprises a coating zone (111) for discharging the exhaust gas containing the VOC, an adsorption apparatus (200) for adsorbing the VOC in the exhaust gas discharged from the coating one (111), and a clean air recycle apparatus for releasing the VOC adsorbed by the adsorption apparatus (200), from the adsorption apparatus (200), thereby to make the adsorbed VOC into a combustion fuel for a regenerative combustion apparatus (300), and for introducing again the clean air cleaned by passing through the adsorption apparatus (200), into the coating zone (111). Further comprised is a filter apparatus body (510) for passing therethrough the exhaust gas discharged from the VOC-generating coating zone (111). The filter apparatus body (510) includes an active carbon cartridge (530) having functions to adsorb and hold a portion of the VOC contained in the exhaust gas discharged from the coating zone (111) and to release a portion of the adsorbed and held VOC if the concentration of the VOC contained in the exhaust gas is low.

### TECHNICAL FIELD

The present invention relates to an exhaust recycling system, and more specifically relates to an exhaust recycling system capable of combustively removing volatile organic compounds (hereinafter referred to as VOCs) contained in the exhaust discharged from a predetermined zone, and recycling the purified air from which VOCs have been removed.

In addition, it relates to an activated carbon filter device applicable to the above-mentioned exhaust recycling system, for example.

### BACKGROUND ART

The system disclosed in Patent Document 1, for example, can be exemplified as a treatment system of exhaust containing VOCs that are generated in a plant or the like. With this system, the VOCs contained in the exhaust are concentrated and collected, and used as the air for combustion in an internal combustion engine. In addition, it is integrated with a power generation system or integrated with a co-generation system by driving a generator by way of an internal combustion engine, for example. According so this system, it is made possible so greatly reduce the running cost and realize energy savings, while having the object of VOC treatment.
Patent Document 1: Japanese Unexamined Patent Application Publication No. 2007-177779

### DISCLOSURE OF THE INVENTION

### Problems to be Solved by the Invention

On the other hand, a system that combustively removes the VOCs contained in the exhaust after having been concentrated and collected has been known as a treatment system for VOCs contained in exhaust. However, with existing systems employing this combustion method, the purified air after VOC removal is atmospherically released. The purified air after VOC removal is normally high temperature to some degree, and thus effective utilization of the purified air has been sought from the viewpoint of energy savings.

In addition, with the technique proposed in Patent Document 1, the VOCs contained in the exhaust are adsorbed and concentrated in an adsorption device that is configured to include zeolites and the like. With this, the VOCs contained in the exhaust are removed, whereby the exhaust is cleaned. In addition, the VOCs adsorbed and concentrated by the adsorption device axe desorbed in a regeneration device to be used as the air for combustion in the internal combustion engine.

However, there has been a problem with this technique in that the adsorption device cannot adequately remove VOCs in the exhaust when the concentration of VOCs contained in the exhaust is high, and thus the exhaust cannot be cleaned.

In addition, since the amount of VOCs adsorbed by the adsorption device decreases when the concentration of VOCs contained in the exhaust is low, there has been a problem in that the air for combustion supplied to the internal combustion engine is lacking.

The present invention has been made taking the above such problems into account, and the object thereof is to provide an exhaust recycling system that is able to combustively remove VOCs in the exhaust discharged from a predetermined zone efficiently, and also recycle the purified air after VOC removal.

In addition, an object is to provide technology that can stabilize the concentration of volatile organic compounds contained in the exhaust supplied to the adsorption device.

### Means for Solving the Problems

The present inventors have thoroughly researched to solve the above-mentioned problems. As a result thereof, they have found that the above-mentioned objects could be achieved by an exhaust recycling system equipped with the following configuration, thereby arriving at completion of the present invention.

In addition, they have found that the above-mentioned objects could be achieved by supplying exhaust discharged from a predetermined zone in which VOCs are generated to the adsorption device via an activated carbon filter device, thereby arriving at completion of the present invention.

More specifically, the present invention provides the following.

An exhaust recycling system according to a first aspect of the present invention includes: a predetermined zone that discharges exhaust containing volatile organic compounds; an adsorption device that adsorbs volatile organic compounds in the exhaust discharged from the predetermined zone; and a purified air recycling device that causes the volatile organic compounds adsorbed to the adsorption device to desorb from the adsorption device to be a combustible fuel for a combustion device, and guides purified air purified by passing through the adsorption device to the predetermined zone again.

According to the present invention, the exhaust recycling system is configured to include: the adsorption device that adsorbs VOCs in the exhaust discharged from the predetermined zone; and the purified air recycling device that causes the VOCs adsorbed to the adsorption device to desorb to be a combustible fuel for a combustion device, and guides purified air purified by passing through the adsorption device to the predetermined zone again.

Since the purified it from which the VOCs have been removed by the adsorption device can be recycled to the predetermined zone and the VOCs adsorbed to the adsorption device can be combustively removed by the combustion device effectively as a result of this, the release of VOCs can be suppressed and energy savings can be achieved.

According to a second aspect of an exhaust recycling system, in the exhaust recycling system as described in the first aspect, the adsorption device includes an adsorption portion that adsorbs volatile organic compounds, a desorption portion that causes the volatile organic compounds thus adsorbed to desorb, and a switching mechanism that can switch between the adsorption portion and the desorption portion, and the purified air recycling device causes volatile organic compounds adsorbed to the adsorption device to desorb by supplying high temperature gas generated while combustively removing volatile organic compounds in the combustion device to the desorption portion.

According to the present invention, the adsorption device is configured to include the adsorption portion that adsorbs VOCs, the desorption portion that causes the VOCs thus adsorbed to desorb, and the switching mechanism that can switch between the adsorption portion and the desorption portion. In addition, the purified air recycling device is configured to causes the VOCs adsorbed to the adsorption device to desorb by supplying high temperature gas generated while combustively removing VOCs in the combustion device to the desorption portion.

The VOCs adsorbed to the adsorption portion thereby desorb, by means of the high temperature gas supplied from the combustion device, and are effectively guided to the combustion device, accompanying the adsorption portion being switched to the desorption portion by the switching mechanism. As a result, efficient removal of the VOCs by combustion becomes possible, as well as the high temperature gas being able to be effectively utilized, which can contribute to energy savings.

According to a third aspect, of an exhaust recycling system, in the exhaust recycling system as described in the first or second aspect, the exhaust recycling system further includes a high temperature gas recycling device that recycles high temperature gas generated while combustively removing volatile organic compounds in the combustion device by guiding the high temperature gas to the predetermined zone.

Conventionally, in a system utilizing a combustion method such as a heat storage combustion method, the high temperature gas (waste heat) generated while combustively removing VOCs is atmospherically released. Therefore, according to the present invention the exhaust recycling system is configured to further include a high temperature gas recycling device that recycles the high temperature gas generated while combustively removing VOCs in the combustion device by guiding to the predetermined zone.

Since the high temperature gas generated while combustively removing VOCs in the combustion device can thereby be recycled, a large energy saving effect is obtained.

According to a fourth aspect of an exhaust recycling system, in the exhaust recycling system as described in any one of the first to third aspects, the purified air recycling device includes: a first main duct for recycling the purified air by guiding to the predetermined zone; a first exhaust duct for releasing the purified air to the atmosphere that branches from the first main duct; and a first damper device that is provided at a branching portion of the first main duct and the first exhaust duct, and has a first valve switching device.

According to a fifth aspect of an exhaust recycling system, in the exhaust recycling system as described in the fourth aspect, the first valve switching device contains an on-off valve that opens and closes a flow path of the first main duct, an exhaust valve that opens and closes a flow path of the first, exhaust duct, and a switching means for opening the flow path of the first exhaust duct by the exhaust valve when the on-off valve closes the flow path of the first main duct, and for closing the flow path of the first exhaust duct by the exhaust valve when the on-off valve opens the flow path of the first main duct, and the switching means operates upon a concentration of volatile organic compounds in the purified air being detected, and operates upon a temperature of the high temperature gas discharged from the combustion device being detected.

According to a sixth aspect of an exhaust recycling system, in the exhaust recycling system as described in any one of the third to fifth aspects, the high temperature gas recycling device includes: a second main duct for recycling the high temperature gas by guiding to the predetermined zone; a second exhaust duct for atmospherically releasing the high temperature as that branches from the second main duct; and a second damper device that is provided at a branching portion of the second main duct and the second exhaust duct, and has a second valve switching device.

According to a seventh aspect of an exhaust recycling system, in the exhaust recycling system as described in the sixth aspect, the second valve switching device has an on-off valve that opens and closes a flow path of the second main duct, an exhaust valve that opens and closes a flow path of the second exhaust duct, and a switching means for opening the flow path of the second exhaust duct by the exhaust valve when the on-off valve closes the flow path of the second main duct, and for closing the flow path of the second exhaust duct by the exhaust valve when the on-off valve opens the flow path of the second main duct, in which the switching means operates upon a concentration of volatile organic compounds in the purified air being detected, and operates upon a temperature of the high temperature gas discharged from the combustion device being detected.

According to the present invention, the purified air recycling device is configured to include the first main duct, the first exhaust duct, and the first damper device equipped with the first valve switching device disposed at a branching portion of this first main duct and first exhaust duct. In addition, the high temperature gas recycling device is configured to include the second main duct, the second exhaust duct, and the second damper device equipped with the second valve switching device disposed at the branching portion of this second main duct and second exhaust duct.

For convenience of explanation, hereinafter, when referred to simply as main duct indicates the first main duct and the second main duct, when referred to simply as exhaust duct indicates the first exhaust duct and the second exhaust duct, when referred to simply as valve switching device indicates the first valve switching device and the second valve switching device, and when referred to simply as damper device indicates the first damper device and the second damper device.

The purified air or high temperature gas thereby flows through the main duct, whereby the purified air or the high temperature gas is recycled to the predetermined zone, in addition, the exhaust duct branches from the main duct, and the purified air or the high temperature gas flows through the exhaust duct to be released to the atmosphere. As a result, purified air or high temperature gas can be safely and reliably recycled to the predetermined zone.

In the present invention, the valve switching device includes an on-off valve, exhaust valve, and switching means. The on-off valve opens and closes the flow path of the main duct. The exhaust valve opens and closes the flow path of the exhaust duct. The switching means opens the flow path of the exhaust duct by the exhaust valve when the on-off valve closes the flow path of the main duct, and closes the flow path of the exhaust duct by the exhaust valve when the on-off valve opens the flow path of the main duct.

The switching means operates upon the concentration of VOCs in the purified air discharged from the adsorption device being detected, and operates upon the temperature of the high temperature gas discharged from the combustion device being detected.

Herein, the fact that the main duct recycles purified air or high temperature gas to the predetermined zone by the purified air or high temperature gas flowing therethrough actually indicates that the exhaust recycling system includes the first main duct through which purified air flows and the second main duct through which high temperature gas flows. The purified air and high temperature gas are merged and preferably made to return to the predetermined zone, by the first main duct and the second main duct being connected after passing the valve switching device.

Similarly, the fact that the exhaust duct branches from the main duct and the purified air or high temperature gas is released to the atmosphere indicates that the exhaust recycling system includes, the first exhaust duct branching from the first main duct and the second exhaust duct branching from the second main duct.

The first damper device includes the first valve switching device disposed at the branching portion of the first main duct and the first exhaust duct, and the second damper device includes the second valve switching device disposed at the branching portion of the second main duct and the second exhaust duct. The first valve switching device and the second valve switching device can function (operate) independently from each other. On the other hand, the first valve switching device and the second valve switching device have the same configuration; therefore, the first valve switching device and the second valve switching device will, be treated as the same device.

In general, damper control arranges a partition plate called a damper inside of a duct, and adjusts the air flow inside a duct by changing the pitch of the damper. In other words, when the damper is disposed so as to be orthogonal to the direction in which a draft flows inside of a duct, the air flow in the duct is minimized, and when the damper is disposed so as to be parallel to the direction in which a draft flows inside of a duct, the air flow in the duct is maximized, whereby the air flow in the duct can be adjusted between minimum and maximum by changing the pitch of the damper.

Normally, the on-off valve opens the flow path of the main duct and the exhaust valve closes the flow path of the exhaust duct; therefore, the main duct configures a closed circuit to guide purified air and high temperature gas to the predetermined zone.

If the VOC concentration of the purified air discharged from the adsorption device is detected to be at least a predetermined value, it can be returned to a normal value by the switching means operating, the on-off valve closing the flow path of the main duct, and the exhaust value opening the flow path of the exhaust duct. In addition, if the temperature of the high temperature gas discharged from the combustion device is detected to be at least a predetermined value, it can be returned to a normal valve by the switching means operating, the on-off valve closing the flow path of the main duct, and the exhaust valve opening the flow path of the exhaust duct.

Herein, the valve switching device according to the embodiment of the present invention has a mechanical interlock function allowing for reverse operations in which, when one damper closes one duct, the other damper opens the other duct, and when one damper opens one duct, the other damper closes the other duct, and thus the reliability of the recycling system is guaranteed.

To recycle purified air, the VOC concentration in the purified air is detected, and in a case of being an inappropriate detected value, the damper device according to the present invention releases this purified air to the atmosphere, and in a case of being an appropriate value, recycles this purified air. Therefore, a certain level of clean air can always be recycled. In addition, the air balance can be brought to a certain range by controlling the switching means so as to exhaust a certain air volume.

In addition, in order for the damper device according to the present invention recycle high temperature gas generated by the combustion device, the switching means operates upon the temperature of the high temperature gas discharged from the combustion device being detected. For example, since the high temperature gas has not reached a predetermined temperature when the combustion device is starting up, this high temperature gas is automatically released to the atmosphere. On the other hand, after the point in time when the high temperature gas reached the predetermined temperature, this high temperature gas is recycled to the predetermined zone.

The damper device according to the present invention in this way can recover heat (thermally recycle) high temperature gas discharged from the combustion device at a predetermined temperature.

According to an eighth aspect of an exhaust recycling system, in the exhaust recycling system as described in any one of the third to seventh aspects, the exhaust recycling system has a double-tube structure composed of an inner tube in which high temperature gas recycled by the high temperature gas recycling device flows, and an outer tube that encircles the inner tube with a gap therebetween and in which purified air recycled by the purified air recycling device flows in the gap.

According to the present invention, the exhaust recycling system is configured to include a double-tube structure composed of an inner tube in which high temperature gas flows, and an outer tube that encircles the inner tube with a gap therebetween and in which purified air flows in the gap. As a result, the high temperature gas flows inside of the inner tube, while the purified air flows through the gap between the inner tube and the outer tube.

Since the high temperature gas is thereby isolated from the open air via the purified air, rapid cooling of the high temperature gas by the open air (i.e. heavy loss in thermal energy) is suppressed, and also the purified air becomes raised in temperature by the thermal energy lost from the high temperature gas. In other words, the purified air and high temperature gas can be efficiently recycled.

According to an ninth aspect of an exhaust recycling system, the exhaust recycling system as described in any one of the third to eighth aspects includes an exhaust recycling system control device, in which the exhaust recycling system control device includes: a static pressure regulated chamber into which the purified air and the high temperature gas are introduced; a fresh air supply mechanism that is provided to the static pressure regulated chamber and supplies fresh air to the predetermined zone; a high temperature gas concentration sensor that is provided to the static pressure regulated chamber and measures a concentration of the high temperature gas in the static pressure regulated chamber; and an exhaust recycle control mechanism that controls an amount of fresh air supplied to the predetermined zone and an amount of purified air recycled, by causing the fresh air supply mechanism to be driven to regulate pressure inside the static pressure regulated chamber, based on the concentration of the high temperature gas measured by the high-temperature gas concentration sensor.

According to the present invention, the exhaust recycling system is configured to include an exhaust recycling system control device. In addition, the exhaust recycling system control device is configured to include a static pressure regulated chamber into which the purified air and high temperature gas are introduced, a fresh air supply mechanism that supplies fresh air to the predetermined zone, a high temperature gas concentration sensor that measures the concentration of the high temperature gas in the static pressure regulated chamber, and an exhaust recycle control mechanism that controls an amount of fresh air supplied to the predetermined zone and an amount of purified air recycled, by causing the fresh air supply mechanism to be driven to regulate pressure inside the static pressure regulated chamber, based on the concentration of the high temperature gas measured by the high-temperature gas concentration sensor.

In the exhaust recycling system that is able to recycle purified air and high temperature gas generated by combustively purifying the VOCs contained in the exhaust discharged from the predetermined zone, it is made possible to control the amount of purified air and the amount of high temperature gas being recycled. Furthermore, safe and stable recycling operation of the exhaust recycling system is made possible.

In addition, an activated carbon filter device according to the present invention has a filter device main body through which exhaust discharged from a predetermined zone in which volatile organic compounds are generated flows, in which the filter device main body includes an activated carbon cartridge having a function of adsorbing and retaining a portion of volatile organic compounds contained in exhaust discharged from the predetermined zone, and of releasing a portion of the volatile organic compounds adsorbed and retained, in a case of a concentration of the volatile organic compounds contained in the exhaust being low.

According to the present invention, a portion of the volatile organic compounds (hereinafter referred to as VOCs) contained in the exhaust is adsorbed and retained in the activated carbon cartridge. Therefore, since a portion of the VOCs is adsorbed and retained by the activated carbon filter device even in a case in which exhaust containing a high concentration of VOCs is discharged, the concentration of VOCs contained in the exhaust supplied to the adsorption device can be reduced.

In addition, in a case in which the concentration of VOCs contained in the exhaust introduced to the activated carbon filter device is low, a portion of the VOCs adsorbed and retained in the activated carbon cartridge is released to be supplied to the adsorption device. Therefore, even in a case in which the concentration of VOCs contained, in the exhaust introduced to the activated carbon filter device is low, the concentration of VOCs contained in the exhaust supplied to the adsorption device can be maintained within a predetermined range.

According to the present invention, the concentration of VOCs contained in the exhaust supplied to the adsorption device can thereby be stabilized.

In addition, the filter device main body preferably includes a housing disposed in a flow path of exhaust discharged from the predetermined zone, and a plurality of activated carbon cartridges disposed to be layered in multiple stages inside of the housing with a predetermined gap in a height direction therebetween, and a plurality of partition plates, each being disposed between two of the activated carbon cartridges that are adjoining, and sloped downward toward a flow direction of the exhaust.

According to the present invention, the plurality of activated carbon cartridges is disposed to be layered in multiple stages with a predetermined gap in the height direction therebetween, and a partition plate is respectively provided between two of the activated carbon cartridges that are adjoining.

Herein, the exhaust discharged from the predetermined zone and introduced to the activated carbon filter device first enters a plurality of gaps formed in the height direction between two adjoining activated carbon cartridges, respectively. Since a partition plate that slopes downward toward the flow direction is respectively disposed in this plurality of gaps, the exhaust having entered these gaps is guided to the partition plate and introduced from the top side of the activated carbon cartridge disposed below this partition plate, and then discharged from the bottom side of this activated carbon cartridge. Since the contact area between the activated carbon cartridge and the exhaust flowing through the activated carbon cartridge can thereby be increased, the adsorption efficiency of VOCs by the activated carbon cartridge can be improved.

In addition, the VOCs have a higher specific gravity than air.

Therefore, the partition plate is made to slope downward toward the flow direction of the exhaust in the present invention. The exhaust is thereby guided to the partition plate, and passes from the top to bottom of the activated carbon cartridge disposed below this partition plate. Consequently, VOCs which have a higher specific gravity than air can be effectively adsorbed and retained in the activated carbon cartridge.

In addition, the housing preferably includes: a first main body portion disposed substantially perpendicular to an introduction direction of the exhaust at a central portion in the width direction of the flow path; a pair of second main body portions that extends from both ends in the width direction of the first main body portion to a downstream side, and is disposed substantially perpendicular to the first main body portion; and a pair of third main body portions that extends outwards from a leading end of each of the pair of second main body portions, and is disposed substantially perpendicular to each of the pair of second main body portions.

According to the present invention, the housing is configured to include the first main body portion, the second main body portion, and the third main body portion. The exhaust introduced to the activated carbon filter device thereby enters the first main body portion and third main body portion disposed substantially perpendicular to the feed direction of exhaust, while as entering from the second main body portion disposed substantially perpendicular to the first main body portion and third main body portion. Therefore, since the exhaust introduced to the activated carbon filter device enters from multiple directions, the velocity at which the exhaust passes through the activated carbon filter device can be decreased, whereby the adsorption efficiency of VOCs can be improved.

In addition, the filter device main body is preferably disposed in plurality with a predetermined gap.

According to the present invention, the filter device main body is disposed in plurality. Since the retention capacity of VOCs by the activated carbon filter device can thereby be increased, the VOC concentration contained in the exhaust supplied to the adsorption device can be further stabilized. In addition, a plurality of the activated carbon cartridges is configured to be detachable with the housing.

According to the present invention, each of the plurality of activated carbon cartridges is configured to be detachable with the housing. Therefore, since it is possible to replace only an activated carbon cartridge requiring replacement among the plurality of activated carbon cartridges, it is easy to perform maintenance of the activated carbon filter device.

In addition, a regulatory mechanism that regulates the flow rate of the exhaust is preferably provided to a bottom portion of the plurality of activated carbon cartridges.

According to the present invention, the regulatory mechanism that regulates the flow rate of exhaust is provided to the bottom portion of the activated carbon cartridges. The released amount of VOCs adsorbed and retained in the activated carbon cartridge can thereby be adjusted by adjusting the regulatory mechanism. Therefore, the concentration of VOCs contained in the exhaust supplied to the adsorption device can be further stabilized.

### Effects of the Invention

According to the present invention, an exhaust recycling system can be provided that can combustively remove VOCs in the exhaust discharged from the predetermined zone efficiently, and recycle the purified air after VOC removal. As a result, it is possible to achieve energy savings and a reduction in the VOC emission amount.

In addition, according to the activated carbon filter device of the present invention, the concentration of VOCs contained in the exhaust supplied to the adsorption device can be stabilized.

### BRIEF DESCRIPTION OF THE DRAWINGS

FIG. 1 is a diagram showing a configuration of a painting facility according to the present invention;

FIG. 2 is a diagram showing a configuration of a filter device;

FIGS. 3A to 3C are diagrams schematically showing each cleaning means in the first cleaning portion and second cleaning portion, respectively;

FIG. 4 is a plan view showing a configuration of an activated carbon filter device;

FIG. 5 is a cross-sectional view along the line X-X in FIG. 4;

FIG. 6A is a plan view of an activated carbon cartridge, and FIG. 5B is a bottom view thereof;

FIG. 7 is a bottom view of an activated carbon cartridge provided with a regulatory mechanism at a bottom portion;

FIG. 8 is a front view of a damper device;

FIG. 9 is a perspective view of a damper device, and is a diagram showing a mode in which a servo motor is used in the driving of the damper device;

FIG. 10 is a perspective view of a damper device, and is a diagram showing a mode in which an air cylinder is used in the driving of the damper device;

FIG. 11 is an overall perspective view of a double-tube structure;

FIG. 12 is a plan view of FIG. 11;

FIG. 13 is a cross-sectional view along the line Y-Y in FIG. 12; and

FIG. 14 is a diagram showing a configuration of a recycling system control device.

### EXPLANATION OF REFERENCE NUMERALS

100 painting facility
110 painting system
111 painting zone (predetermined zone)
120 VOC removal system
130 recycling system
200 adsorption device
300 regenerative thermal oxidizer
400 filter device
410 exhaust inlet
420 exhaust outlet.
430 filter
440 roller
450 first cleaning portion
460 second cleaning portion
500 activated carbon filter device
510 filter device main body
520 housing
521 first main body portion
522 second main body portion
523 third main body portion
530 activated carbon cartridge
531 regulatory mechanism.
540 partition plate
590 flow path
610 first damper device
620 second damper device
611 on-off valve
612 exhaust valve
613 switching means
723 second main duct
735 first main duct
720 inner tube
726 second exhaust duct
736 first exhaust duct
730 outer tube
800 recycling system control device
820 CO₂ sensor
850 static pressure regulated chamber
860 feed port

### PREFERRED MODE FOR CARRYING OUT THE INVENTION

A preferred embodiment of an exhaust recycling system according to the present invention will be explained hereinafter with reference to the drawings. The present embodiment applies the exhaust recycling system of the present invention to a painting facility that performs painting of automobile bodies.

It should be noted that “applying” in the present invention includes “painting”, “printing”, and “coating”.

In addition, “paints” includes paint used in painting and inks used in printing.

### Overall Configuration

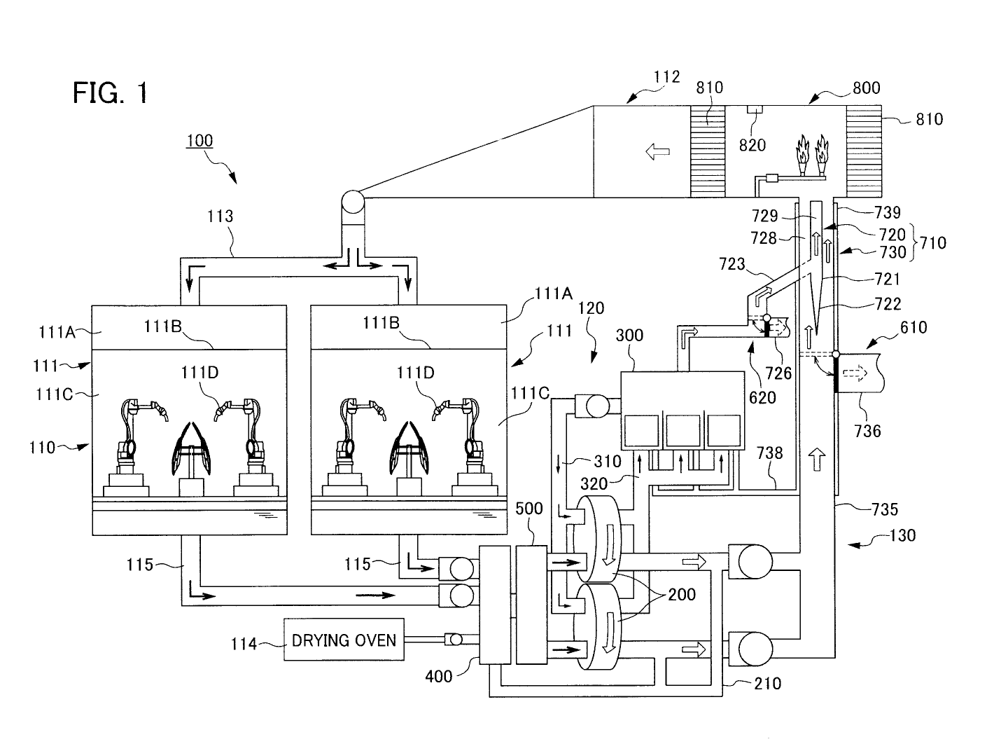

FIG. 1 is a diagram showing the configuration of a painting facility 100 as an application facility of the present invention.

The painting facility 100 is a facility that performs painting of the body or an automobile as an application target, and includes a painting system 110 as an application system that conducts painting on the body, a VOC removal system 120 that combustively removes VOCs contained in the exhaust emitted from this painting system 110, and a recycling system 130 provided with a purified air recycling device and a high temperature gas recycling device for recycling purified air that was purified by this VOC removal system 120 and high temperature gas produced during combustion by guiding to the painting system 110.

The painting system 110 includes a plurality of painting zones 111 as predetermined zones disposed along a conveying direction of automobile bodies, an air supply device 112 that conditions and supplies air to this plurality of painting zones 111, an air supply channel 113 through which conditioned air flows, and a drying oven 114 that dries the painted subject on which painting has been conducted in the plurality of painting zones 111.

The air supply device 112 includes an air conditioning unit (not illustrated) that conditions fresh air and recycled gas supplied by a recycling system control device 800 described later, and an air supply fan (not illustrated) that leads out the conditioned air.

Provided inside of the painting zone 111 are a static pressure room 111A that deals with the air supply channel 113 to drop the velocity by causing the air supplied to diffuse and raises the pressure, an upper rectifier plate 111B that temporarily blocks the bottom of this static pressure room 111A and makes the air into a downward pointing flow to spray downward, a painting room 111C positioned below this upper rectifier plate 111B, a painting robot 111D that is disposed in this painting room 111C and paints the painting subject, and an exhaust supply channel 115.

Painting is conducted by the painting robot 111D on the painting subject in the painting zone 111. The VOCs, paint mist, paint residue, and the like generated during painting thereby become included in the air inside the painting zone 111.

With the air supply device 112, fresh air and recycled gas supplied by the recycling system control device 800 described later are mixed and then conditioned by the air conditioning unit, and then pass through the air supply channel 113 to be supplied teach of the plurality of painting zones 111 by the air supply fan.

The air supplied from the air supply device 112 is discharged from the plurality of painting zones 111 to the exhaust supply channel 115 by an exhaust fan (not illustrated).

The VOC removal system 120 includes a filter device 400 through which exhaust discharged from the painting zone 110 passes, an activated carbon filter device 500 that is provided downstream of this filter device 400 and through which exhaust having passed through the filter device 400 passes, an adsorption device 200 that is provided downstream of this activated carbon filter device 500 and adsorbs VOCs contained in the exhaust having passed through the activated carbon filter device 500, and a regenerative thermal oxidizer 300 as a combustion device that combustively removes VOCs adsorbed to this adsorption device 200.

The filter device 400 is disposed in the flow path of exhaust discharged from the painting system 110, and removes paint mist and paint residue contained in the exhaust discharged from the plurality of painting zones 111 and the drying oven 114.

The activated carbon filter device 500 adsorbs a portion of the VOCs contained in the exhaust discharged from the painting zones 110, and adjusts the VOC concentration in the exhaust supplied so the adsorption device 200 provided on a downstream side of the activated carbon filter device 500, by gradually releasing this portion of the VOCs adsorbed.

More specifically, when the concentration of VOCs contained in the exhaust is high, the activated carbon filter device 500 adsorbs a portion thereof. In addition, a portion of the VOCs adsorbed to the activated carbon filter device 500 is released when the concentration of VOCs contained in the exhaust passing through the activated carbon filter device 500 is low. The supply of VOCs to the regenerative thermal oxidizer 300, which is described later, does not cease, even when painting is temporarily not performed in the painting zone 111.

In addition, the activated carbon filter device 500 has an effect of removing substances hindering the VOC adsorptive capacity of the zeolite used by the adsorption device 200 described later.

The adsorption device 200 is a cylindrical shape, and is configured to contain zeolite as a VOC adsorbent. The exhaust having passed through the activated carbon filter device 500 passes through this adsorption device 200, whereby the VOCs are adsorbed and removed therefrom. The adsorbed VOCs are concentrated by this adsorption device 200.

Two of the adsorption devices 200 are disposed in parallel in the flow path of the exhaust, and are configured to allow for separate uses such as main and sub, for example, in addition to being used simultaneously.

In addition, the adsorption device 200 includes an adsorption portion that adsorbs VOCs, a desorption portion that causes the adsorbed VOCs to desorb, and a switching mechanism that can switch between the adsorption portion and the desorption portion. As a result, with the adsorption device 200, the VOCs are adsorbed in the adsorption portion through which exhaust having passed through the aforementioned activated carbon filter device 500 passes. The VOCs are desorbed in the desorption portion through which the high temperature gas generated by the regenerative thermal oxidizer 300 described later pass via a first high temperature gas supply channel 310 provided by the purified air recycling device described later. The adsorption device 200 includes a motor as a switching mechanism, and is made to be rotatable by this motor around a shaft with the flow direction of exhaust as an axis. Switching between the adsorption portion and desorption portion is performed by this rotation.

The purified air that has been purified by passing through the adsorption device 200 is guided to the painting system 110 by the recycling system 130. In addition, the VOCs desorbed from the adsorption device 200 pass through the VOC supply channel 320 provided by the purified air recycling device described later and are supplied to the regenerative thermal oxidizer 300 described later.

The regenerative thermal oxidizer 300 combustively removes the VOCs adsorbed and concentrated by the adsorption device 200. As mentioned above, VOCs adsorbed and concentrated in the adsorption device 200 are desorbed by means of the high temperature gas supplied through the first high temperature gas supply channel 310 to the regenerative thermal oxidizer 300. The regenerative thermal oxidizer 300 is a three-tower regenerative thermal oxidizer, whereby a large amount of VOCs undergo pyrolysis treatment efficiently. The VOCs supplied to the regenerative thermal oxidizer 300 undergo pyrolysis treatment at high temperatures of approximately 800° C. or higher, and are converted to water and carbon dioxide.

As mentioned above, a portion of the high temperature gas (waste heat) generated during combustive removal of VOCs is used in the desorption of the VOCs adsorbed in the adsorption device 200. In addition, this portion of high temperature gas is guided to the painting zone 110 by the recycling system 130 described later.

The recycling system 130 includes a purified air recycling device that causes the VOCs adsorbed to the adsorption device 200 to desorb to be a combustible fuel for the regenerative thermal oxidizer 300, and that guides the purified air that was purified by passing through the adsorption device 200 to the painting zone 111 again, and a high temperature gas recycling device that guides high temperature as produced during the combustive removal of VOCs by the regenerative thermal oxidizer 300 to the painting zone 111.

The purified air recycling device includes a first main duct 735 for recycling purified air by guiding to the painting zone 111, a first exhaust duct 736 for releasing purified air to the atmosphere that branches from the first main duct 735, and a first damper device 610 provided at a branching portion between the first main duct 735 and the first exhaust duct 736 that includes a first valve switching device. The high temperature gas recycling device includes a second main duct 723 for recycling by guiding high temperature gas to the painting zone 111, a second exhaust duct 726 for releasing high temperature gas to the atmosphere that branches from the second main duct 723, and a second damper device 620 provided at the branching portion between the second main duct 723 and the second exhaust duct 726 that includes a second valve switching device.

It is thereby possible to atmospherically release purified air and high temperature gas reliably, during any abnormal state. For example, in a case in which the pyrolysis treatment temperature has not reached a certain temperature in the regenerative thermal oxidizer 300 such as during the startup of the regenerative thermal oxidizer 300, the first damper device 610 and second damper device 620 are opened and purified air and high temperature gas are atmospherically released since the removal of VOCs by the VOC removal system 120 has not been adequately carried out, whereby recycling is not executed.

In addition, the recycling system 130 includes a double-tube structure 710 composed of an inner tube 720 through which the high temperature gas recycled by the high temperature gas recycling device flows, and an outer tube 730 that encircles this inner tube 720 with a gap and in which purified air recycled by the purified air recycling device flows in the gap.

The outer tube 730 is provided so as to encircle the inner tube 720, and the double-tube structure 710 is formed by this outer tube 730 and inner tube 720. The high temperature gas flows to the inner tube 720 via the second main duct 723. The purified air flows to the outer tube 730 via the first main duct 735. The purified air flowing in the outer tube 730 is warmed by the high temperature gas flowing in the inner tube 720. In other words, the high temperature gas (waste heat) generated in the regenerative thermal oxidizer 300 is effectively utilized as a means for warming the purified air to a predetermined temperature that is necessary when supplying purified air to the painting system 110, whereby energy savings is achieved.

In addition, a portion of the high temperature gas generated by the regenerative thermal oxidizer 300 leads to the supply tube 738 and is utilized in insulation of the outer tube 730. As a result, a temperature decline in the purified air flowing in the outer tube 730 is suppressed, particularly in the winter season.

In addition, the recycling system 130 includes a recycling system control device 800 that controls the amount of purified air and the amount of high temperature gas recycled by this recycling system 130. The amount of purified air and the amount of high temperature gas recycled in the painting system 110 is controlled by this recycling system control device 800 based on the high temperature as concentration, and additionally the amount of fresh air supplied to the painting system 110 is controlled.

According to the above painting facility 100, the exhaust discharged from the painting system 110 is guided to the painting system 110 again to be recycled by the recycling system 130 after paint mist, paint residue, and VOCs are removed by the VOC removal system 120. Consequently, exhaust from which VOCs have been removed by the adsorption device 200 can be recycled, and VOCs adsorbed and concentrated by this adsorption device 200 can be combustively removed by the regenerative thermal oxidizer 300 efficiently; therefore, the release of VOCs can be suppressed and energy savings can be achieved.

In addition, the high temperature gas generated by the regenerative thermal oxidizer 300 while combustively removing VOCs can also be recycled by guiding to the painting system 110 through the inner tube 720 serving as a high temperature gas recycling device; therefore, the energy saving effect can be further improved.

Moreover, the high temperature gas (waste heat) generated from the regenerative thermal oxidizer 300 used in the removal of VOCs is utilized in the warm air of the purified air recycled; therefore, the energy savings is further improved.

It should be noted that, although operation of the entire painting facility 100 of the present embodiment is as described above, the details thereof will be explained in detail below for every configuration.

### Filter Device

The filter device 400 will be explained next.

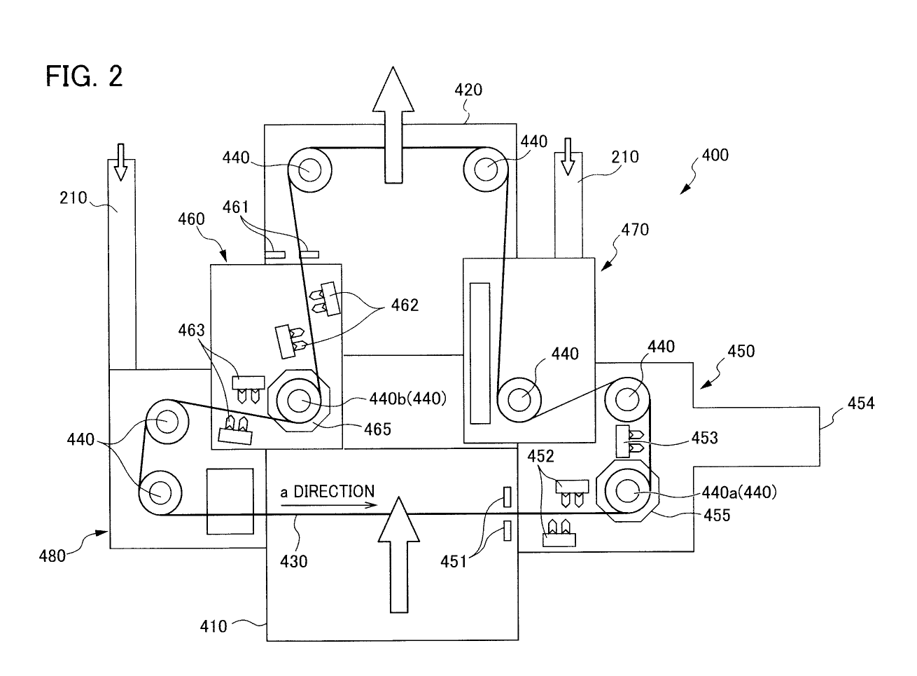

FIG. 2 is a diagram showing the configuration of the filter device 400.

The filter device 400 is disposed in the flow path of the exhaust discharged from the painting system 110, and removes the paint mist, paint residue, and the like contained in the exhaust discharged from the plurality of painting zones 111 and the drying oven 114.

The filter device 400 includes an exhaust inlet 410, an exhaust outlet 420, a filter 430 of an endless form disposed so as to cover the exhaust inlet 410 and exhaust outlet 420, respectively, a plurality of rollers 440 that rotatably support the filter 430, a first cleaning portion 450 and second cleaning portion 460 that clean the filter 430, and a first filter drying portion 470 and a second filter drying portion 480 as filter drying portions that dry the filter 430 cleaned by this first cleaning portion 450 and second cleaning portion 460.

The exhaust inlet 410 and the exhaust outlet 420 are provided to be facing each other.

The filter 430 of endless form is supported by the plurality of rollers 440, and is disposed between the exhaust inlet 410 and the exhaust outlet 420. The filter 430 is disposed at a position covering the exhaust inlet 410 and a position covering the exhaust outlet 420 so as to make substantially a right angle with the flow path of exhaust.

At least one of the rollers 440 among the plurality of rollers 440 is connected to a motor (not illustrated). Then, the filter 430 supported by the rollers 440 is rotationally moved at a constant speed in a predetermined direction (a-direction in FIG. 2) by driving this motor to rotate the roller 440.

The first cleaning portion 450 is provided on an upstream side of the exhaust outlet 420, which is on a downstream side of the exhaust inlet 410.

The first cleaning portion 450 includes neutralization blow bars 451 as a static charge eliminating means, active hydrogen water injection devices 452 as a cleaning liquid spraying means, an air blowing device 453 as a gas blowing means, an exhaust port 454 that discharges the gas blown by this air blowing device 453, and a micro-vibration generating device 455 as a filter vibrating means for causing the filter 430 to undergo micro-vibrations in the first cleaning portion 450.

The neutralization blow bars 451 are disposed on an external side and internal side of the filter 430, and blow a gas containing an electric charge onto the external side and internal side of the filter 430. The static charge of a statically charged filter 430, paint mist, and paint residue is thereby eliminated.

The active hydrogen water injection devices 452 are disposed on a downstream side of the neutralization blow bars 451. The active hydrogen water injection devices 452 are disposed on an external side and internal side of the filter 430, and spray active hydrogen water containing hydroxyl ions as a cleaning liquid onto the filter 430. The paint mist and paint residue adhered to the filter 430 is thereby made easily separable from the filter 430.

The air blowing device 453 is disposed on a downstream side of the active hydrogen water injection device 452. The air blowing device 453 is disposed on an internal side of the filter 430, and blows air toward the external side of the filter 430 from the internal side thereof. The paint mist and paint residue adhered to the filter 430 is thereby removed from the filter 430.

The paint mist and paint residue removed from the filter 430 is discharged from the exhaust port 454 along with the air blown by the air blowing device 453.

One roller 440a among the plurality of rollers 440 is disposed between the active hydrogen water injection devices 452 and the air blowing device 453.

The micro-vibration generating device 455 is attached to the roller 440a. The filter 430 undergoes micro-vibrations in the first cleaning portion 450 by driving this micro-vibration generating device 455.

The second cleaning portion 460 is provided on an upstream side of the exhaust inlet 410, which is on a downstream side of the exhaust outlet 420.

The configuration of the second cleaning portion 460 is a configuration similar to the first cleaning portion 450 except for the arrangement of the air blowing devices 463 differing. More specifically, the second cleaning portion 460 includes neutralization blow bars 461, active hydrogen water injection devices 462, air blowing devices 463, an exhaust port 464 (not illustrated), and a micro-vibration generating device 465.

In the second cleaning portion 460, the air blowing devices 463 are disposed on an internal side and an external side of the filter 430. Then, air is blown toward the external side of the filter 430 from the internal side thereof from the air blowing device 430 disposed on the internal side of the filter 430, and air is blown toward the internal side of the filter 430 from the external side thereof from the air blowing device 463 disposed on the external, side of the filter 430.

The first filter drying portion 470 is provided adjacent to the first cleaning portion 450 on a downstream side of the first cleaning portion 450, and the second filter drying portion 480 is provided adjacent to the second cleaning portion 460 on a downstream side of the second cleaning portion 460.

Purified air that has been warmed and made low humidity by passing through the adsorption device 200 is introduced to the first filter drying portion 470 and the second filter drying portion 480 via a purified air supply channel 210, whereby the filter 430 cleaned by the first cleaning portion 450 and the filter 430 cleaned by the second cleaning portion 460 are dried.

The above filter device 400 operates as follows.

First, when a motor (not illustrated) is driven, the roller among the plurality of rollers 440 that is connected to the motor rotates, and the filter 430 supported to the plurality of rollers 440 rotationally moves at a constant speed in a predetermined direction.

In this state, exhaust discharged from the painting system 110 is introduced from the exhaust inlet 410. The exhaust introduced from the exhaust inlet 410 first passes through a portion of the filter 430 of endless form covering the exhaust inlet 410 from the external side of the filter 430 to the internal side thereof. The paint mist and paint residue contained in the exhaust is thereby collected by mainly adhering to the external side of the filter 430.

The exhaust having passed through the portion of the filter 430 covering the exhaust inlet 410 then passes through a portion of the filter 430 of endless form covering the exhaust outlet 420 from the internal side of the filter 430 toward the external side thereof. The paint mist and paint residue that has not been collected by the portion of the filter 430 positioned at the exhaust inlet 410 is collected by mainly adhering to the internal side of the filter 430 at a portion of the filter 430 covering the exhaust outlet 420.

Herein, since the filter 430 rotationally moves at a constant speed in a predetermined direction, the paint mist and paint residue adhered to the portion of the filter 430 covering the exhaust inlet 410 is removed by the first cleaning portion 450 provided on a downstream side of the exhaust inlet 410 in addition, the paint mist and paint residue adhered to the portion of the filter 430 covering the exhaust outlet 420 is removed by the second cleaning portion 460 provided on a downstream side of the exhaust outlet 420.

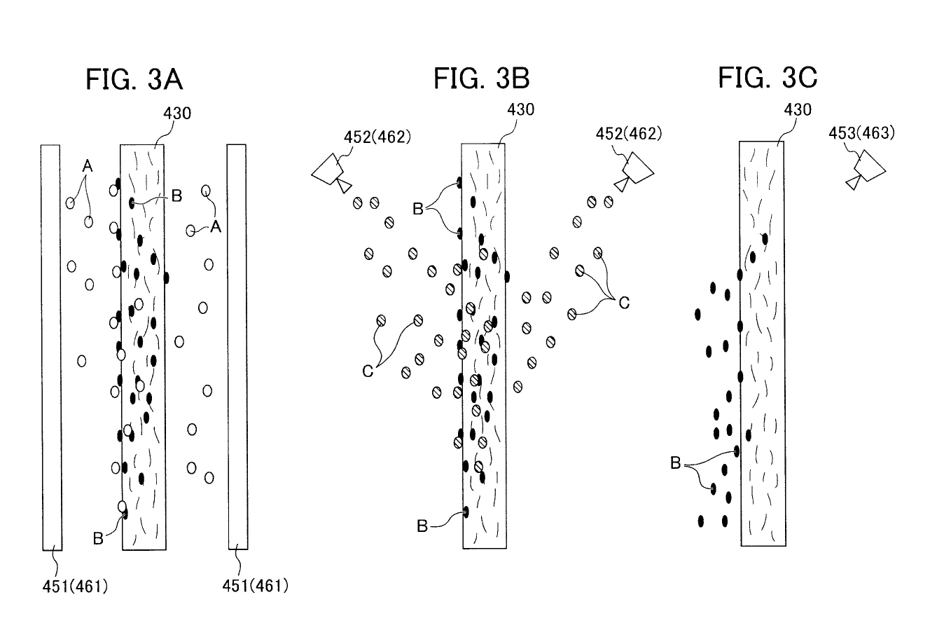

FIGS. 3A to 3C are diagrams schematically showing each cleaning means of the first cleaning portion 450 and the second cleaning portion 460, respectively. It should be noted that A in FIG. 3 indicates gas containing an electric charge, B indicates paint mist and paint residue, and C indicates active hydrogen water.

In the first cleaning portion 450, first, the gas A containing an electric charge is blown to the external side and internal side of the filter 130 by the neutralization blow bars 451, as shown in FIG. 3A. The static charge of the filter 430, and the paint mist and paint residue B is thereby eliminated.

Next, the active hydrogen water C containing hydroxyl ions is sprayed onto the filter 430 by the active hydrogen water injection devices 452, as shown in FIG. 3B. The paint mist and paint, residue B adhered to the filter 430 is thereby made easily separable from the filter 430.

Next, the air (not illustrated) is blown from the internal side of the filter 430 toward the external side thereof by the air blowing device 453, as shown in FIG. C. The paint mist and paint residue B adhered to the filter 430 is thereby separated to the external side of the filter 430 and removed from the filter 430.

The paint mist and paint residue B removed from the filter 430 is discharged from the exhaust port 451 along with the air blown by the air blowing device 453.

The micro-vibration generating device 455 is disposed between the active hydrogen water injection devices 462 and air blowing devices 463, and the filter 430 undergoes micro vibrations in the first cleaning portion 450 by driving this micro-vibration generating device 455. The paint mist and paint residue adhered to the filter 430 thereby easily detaches from the filter 430.

The paint mist and paint residue are removed from the filter 430 also in the second cleaning portion 460 by a process similar to the first cleaning portion 450.

The filter 430 from which paint mist and paint residue have been removed by the first cleaning portion 450 is dried by the first filter drying portion 470. The purified air warmed while passing through the adsorption device 200 is introduced to this first filter drying portion 470.

Similarly, the filter 430 from which the paint mist and paint residue have been removed by the second cleaning portion 460 is dried by the second filter drying portion 480. The purified air that has been warmed and made low humidity by passing through the adsorption device 200 is introduced also to this second filter drying portion 480.

The filter 430 that has been dried by the first filter drying portion 470 moves to a downstream side, and removes paint mist and paint residue remaining in the exhaust introduced from the exhaust inlet 410 at a portion thereof covering the exhaust cutlet 420.

The filter 430 that has been dried by the second filter drying portion 480 moves to a downstream side, and removes the paint mist and paint residue contained in the exhaust discharged from the painting system 110 at a portion thereof covering the exhaust inlet 410.

The following effects are exerted according to the above filter device 400.

The filter 430 of endless form is disposed so as to cover the exhaust inlet 410 and the exhaust outlet 420, respectively, and additionally the first cleaning portion 450 is provided on a downstream side of the exhaust inlet 410 and the second cleaning portion 460 is provided on a downstream side of the exhaust outlet 420. The exhaust introduced from the exhaust inlet 410 thereby passes through a portion of the filter 430 of endless form covering the exhaust inlet 410, and then further passes through a portion of the filter 430 of endless form covering the exhaust outlet 420. Consequently, it is possible to efficiently remove the paint mist and paint residue contained in the exhaust discharged from the painting system 110.

In addition, the paint mist and paint residue removed at the portion of the filter 430 covering the exhaust inlet 410 by adhering to the filter 430 is removed from the filter 430 by the first cleaning portion 450, and the paint mist and paint residue removed at the portion of the filter 430 covering the exhaust outlet 420 by adhering to the filter 430 is removed from the filter 430 by the second cleaning portion 460. Since the filter 430 is thereby always positioned at the exhaust inlet. 410 and exhaust outlet. 420 in a state in which the paint mist and paint residue have been removed, clogging of the filter 430 does not occur, even with the elapse of time. Consequently, the frequency of maintaining the filter device 400 can be reduced.

In addition, the first cleaning portion 450 and the second cleaning portion 460 are respectively configured to include the neutralization blow bars 451, the active hydrogen water injection devices 452, and the air blowing device 453. Consequently, the cleaning effect of the filter 430 is improved by the first cleaning portion 450 and the second cleaning portion 460, whereby the paint mist and paint residue adhered to the filter 430 can be effectively removed.

In addition, the first cleaning portion 450 and the second cleaning portion 460 are respectively configured to include the micro-vibration generating devices 455 and 465 that cause the filter 430 to undergo micro-vibrations. Consequently, the paint mist and paint residue adhered to the filter 430 become easily detached from the filter 430 at the first cleaning portion 450 and the second cleaning portion 460.

In addition, the first filter drying portion 470 is provided on a downstream side of the first cleaning portion 450, and the second filter drying portion 480 is provided on a downstream side of the second cleaning portion 460. The filter 430 cleaned by the first cleaning portion 450 and the second cleaning portion 460 is thereby dried and disposed at the exhaust inlet 410 and the exhaust outlet 420. Therefore, the removal effect of the paint mist and paint residue can be stabilized by the filter device 400.

In addition, purified air that has passed through the adsorption device 200 is introduced to the first filter drying portion 470 and the second filter drying portion 480, respectively. Since the purified air that has been warmed and made low humidity by passing through the adsorption device 200 is thereby used in drying of the filter 430, the purified air can be effectively used.

It should be noted that the filter device used in the painting facility 100 of the present embodiment is not to be limited to the embodiment, and modifications, improvements, and the like within a scope that can achieved the objects of the present invention are included in the present invention.

For example, although the active hydrogen water injection devices 452 are used as a cleaning liquid spraying means and active hydrogen water is used as the cleaning liquid in the present embodiment, it is not limited thereto, and a surfactant may be used as the cleaning liquid.

### Activated Carbon Filter Device

The activated carbon filter device 500 will be explained next.

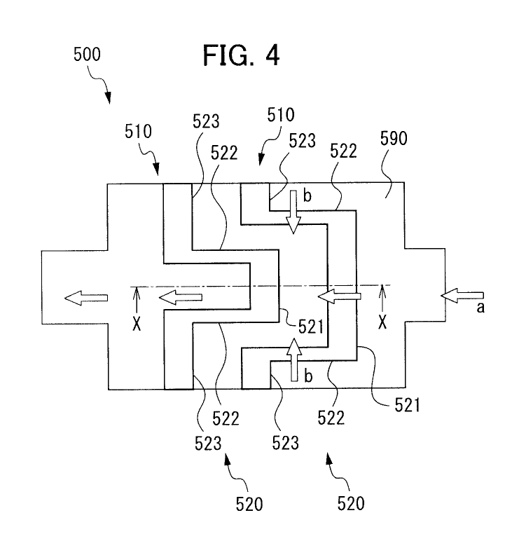

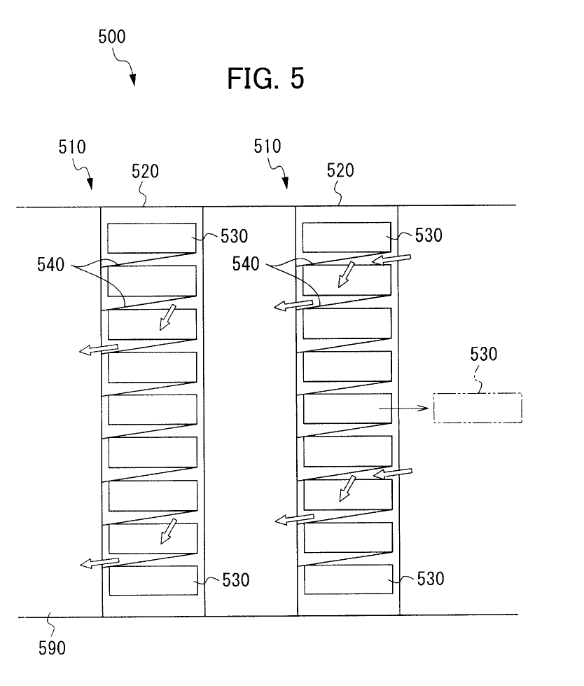

FIG. 4 is a plan view showing the configuration of the activated carbon filter device 500. FIG. 5 is a cross-sectional view along the line X-X in FIG. 4.

The activated carbon filter device 500 regulates the VOC concentration in the exhaust supplied to the adsorption device 200 provided on a downstream side of this activated carbon filter device 500.

The activated carbon filter device 500 is provided on a downstream side of the filter device 400, and includes two filter device main bodies 510 disposed in the flow path 590 of exhaust having passed through the filter device 400. The two filter device main bodies 510 are disposed on an upstream side and downstream side of the flow path 590 with a predetermined interval therebetween.

The filter device main body 510 includes a housing 520, a plurality of activated carbon cartridges 530 disposed inside of this housing 520, and a plurality of partition plates 540 disposed inside of this housing 520.

Each of the plurality of activated carbon cartridges 530 is housed inside of the housing 520 to be disposed, layered in multiple stages with predetermined gap in the height direction therebetween. More specifically, each of the plurality of activated carbon cartridges 530 have a substantially rectangular shape, and is arranged in a plurality of rows in the width direction of the housing 520, as well as being arranged in a plurality of columns in the height direction of the housing 520.

The plurality of partition plates 540 is respectively disposed in the gap formed between two adjoining activated carbon cartridges in the height direction. This plurality of partition plates 540 slopes downward toward the exhaust flow direction.

Herein, the exhaust flow direction indicates the direction in which the exhaust passes when the exhaust passes through the housing 520.

The housing 520 includes a first main body portion 521, a pair of second main body portions 522, and a pair of third main body portions 523.

The first main body portion 521 is disposed substantially perpendicular to the exhaust feed direction (a direction in FIG. 4), in the center in the width direction of the flow path 590 of the exhaust having passed through the filter device 400.

The pair of second main body portions 522 extends from both ends in the width direction of the first main body portion 521 to the downstream side of the flow path 590, and is disposed substantially perpendicular to this first main body portion 521.

The pair of third main body portions 523 extends outwards from the leading end of each of the pair of second main body portions 522, and is disposed substantially perpendicular to each of the pair of second main body portions 522.

In this way, two housing 520 (filter device main bodies 510) are disposed in the flow path 590 in a finish podium shape facing the upstream side.

The activated carbon filter device 500 thereby covers the entire area of the flow path 590.

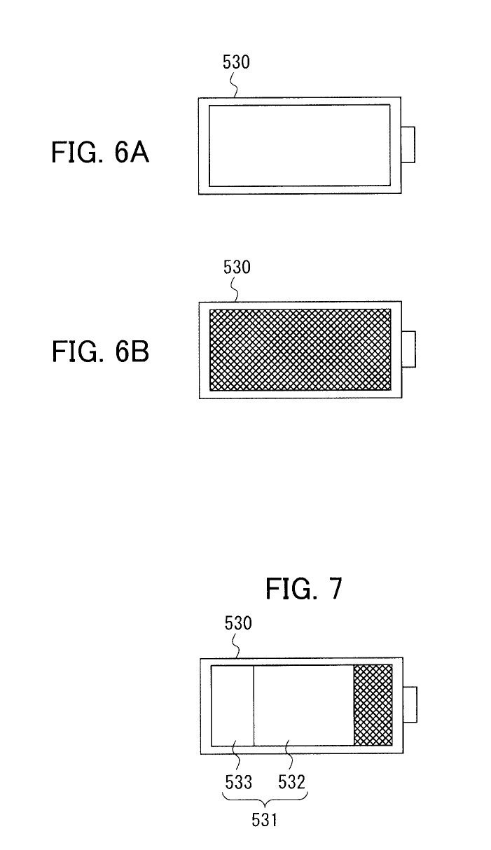

FIG. 6A is a plan view of the activated carbon cartridge 530, and FIG. 6B is a bottom view of the activated carbon cartridge 530. FIG. 7 is a bottom view of the activated carbon cartridge 530 provided with a regulatory mechanism 531 at a bottom portion.

The activated carbon cartridge 530 is formed by filling activated carbon 535 in the cartridge main body 534 in which the bottom portion and side portions are configured from mesh members. A grip 536 is provided to this cartridge main body 534.

In addition, the regulatory mechanism 531 that regulates the flow rate of exhaust passing through this activated carbon cartridge 530 is provided to the bottom portion of a predetermined activated carbon cartridge 530 among the plurality of activated carbon cartridge 530, as shown in FIG. 7.

The regulatory mechanism 531 is configured from two plate members 532 and 533 of substantially the same form, and covers the bottom portion of the activated carbon cartridge 530 with these two plate members 532 and 533. One plate member 532 among the two plate members 532 and 533 is configured to be slidable to the other plate member 533 side, whereby the opened area of the bottom portion of the activated carbon cartridge 530 is made adjustable by this one plate member 532 being slid.

The plurality of activated carbon cartridges 530 is configured to be detachable with the housing 520. More specifically, the plurality of activated carbon cartridges 530 disposed to be accommodated in the first main body portion 521 and the pair of third body portions 523 is configured to be able to attach and detach with the housing 520 from the upstream side (refer to the two-dot dashed line portion of FIG. 5). In addition, the plurality of activated carbon cartridges 530 disposed to be accommodated in the pair of second main body portions 522 is configured to be able to attach and detach with the housing 520 from an outer side (sidewall side of the flow path 590).

The flow of exhaust in the activated carbon filter device 500 will be explained next.

When the exhaust having passed through the filter device 400 is introduced to the activated carbon filter device 500, the exhaust introduced from the exhaust inlet 410 first reaches the filter device main body 510 disposed on an upstream side. Then, it enters the plurality of gaps respectively formed between two adjoining activated carbon cartridges 530 in the height direction inside of the housing 520. Since the partition plates 540 sloped downward toward the flow direction are disposed between each of this plurality of gaps, the exhaust having entered these gaps is guided to the partition plate 540 and introduced from a top side of the activated carbon cartridge 530 disposed below this partition plate 540, and then discharged from the bottom side of this activated carbon cartridge 530.

A portion of the VOCs contained in the exhaust is thereby adsorbed to the activated carbon cartridge and temporarily retained. In addition, in a case of the concentration of VOCs contained in the exhaust introduced to the activated carbon filter device 500 being low, the portion of VOCs adsorbed and retained in the activated carbon cartridge 530 is released into the exhaust.

Moreover, substances hindering the VOC adsorptive capacity of the zeolite used in the adsorption device 200 are removed by this plurality of activated carbon cartridges 530.

The regulatory mechanism 531 is provided to the bottom portion of a predetermined activated carbon cartridge 530 among the plurality of activated carbon cartridge 530.

In the activated carbon cartridge 530 in which the regulatory mechanism 531 is provided at a bottom portion, since the exhaust does not pass through the activated carbon cartridge 530 in which the bottom portion is covered in a state in which this bottom portion is covered by two of the plate members 532 and 533, the VOCs adsorbed and retained to this activated carbon cartridge 530 are not released into the exhaust.

On the other hand, in a state in which one of the plate members 532 among the two plate members 532 and 533 is made to slide and a portion of the bottom portion is opened, since the exhaust can pass through the opened portion of the bottom portion, a portion of the VOCs adhered and retained in this activated carbon cartridge is released.

With the activated carbon cartridge 530 in which the regulatory mechanism 531 is provided to the bottom portion in this way, the released amount of VOCs adhered and retained in this activated carbon cartridge 530 can be adjusted by adjusting the area of the opened portion of the bottom portion by opening and closing the two plate members 532 and 533.

The exhaust having reached the filter device main body 510 passes through the activated carbon cartridge 530 by entering from the first main body portion 521 and the pair of third main body portions 523 configuring the housing 520 along the flow direction (a direction in FIG. 4) of the exhaust having been introduced.

Meanwhile, exhaust passes through the activated carbon cartridge 530 by entering from the pair of second main body portions 522 in a direction substantially orthogonal (b direction in FIG. 4) to the flow direction of exhaust having been introduced.

The exhaust having passed through the filter device main body 510 disposed on an upstream side subsequently reaches the filter device main body 510 disposed on the downstream side. In the filter device main body 510 disposed on a downstream side, the exhaust passes through the filter device main body 510 disposed on this downstream side in a state similar to the case of passing through the filter device main body 510 disposed on the upstream side.

The exhaust having passed through the filter device main body 510 disposed on the downstream side is subsequently supplied to the adsorption device 200.

The following effects are exerted according to the above activated carbon filter device 500.

The plurality of activated carbon cartridges 530 is disposed to be layered in multiple stages with predetermined gaps in the height direction, and partition plates 540 are provided between two adjoining activated carbon cartridges 530, respectively.

The exhaust discharged from the filter device 400 and introduced to the activated carbon filter device 500 is thereby guided to the partition plate 540 and introduced from a top side of the activated carbon cartridge 530 disposed below this partition plate 540, and discharged from the bottom side of this activated carbon cartridge 530. Consequently, since a portion of the VOCs contained in the exhaust is adhered and retained in the activated carbon cartridge 530, the concentration of VOCs contained in the exhaust supplied to the adsorption device 200 can be reduced even in a case in which exhaust containing a high concentration of VOCs is discharged.

In addition, in a case of the concentration or VOCs contained in the exhaust introduced to the activated carbon filter device 500 being low, a portion of the VOCs adhered and temporarily retained in the activated carbon cartridge 530 is released and supplied to the adsorption device 200. Consequently, the concentration of VOCs contained in the exhaust supplied to the adsorption device 200 can be maintained in a predetermined range, even in a case in which the concentration of VOCs contained in the exhaust introduced to the activated carbon filter device 500 is low.

The concentration of VOCs contained in the exhaust supplied to the adsorption device 200 can thereby be stabilized.

In addition, since the contact area between the exhaust passing through the activated carbon filter device 500 and the activated carbon cartridge 530 can be expanded, the adsorption efficiency of VOCs by the activated carbon cartridge 530 can be improved.

Moreover, the partition plates 540 are made to slope downward toward the flow direction of the exhaust. The exhaust is thereby guided to the partition plate 540, and passes through from the top of the activated carbon cartridge 530 disposed below this partition plate 540 to the bottom. Consequently, VOCs haying a higher specific gravity than air can be effectively adsorbed and retained to the activated carbon cartridge 530.

In addition, the housing 520 is configured to include the first main body portion 521, the second main body portion 522, and the third main body portion 523. The exhaust introduced to the activated carbon filter device 500 thereby enters from the first main body portion 521 and third main body portion 523 disposed substantially perpendicular to the flow direction of exhaust, and additionally enters from the second main body portion 522 disposed substantially perpendicularly to the first main body portion 521 and the third main body portion 523. Consequently, since the exhaust introduced to the activated carbon filter device 500 enters from multiple directions, the velocity at which the exhaust passes through the activated carbon filter device 500 can be decreased, whereby the VOC adsorption efficiency can be improved.

In addition, two of the filter device main bodies 510 are disposed in the flow direction of exhaust. Since the retention capacity of VOCs by the activated carbon filter device 500 can thereby be increased, the VOC concentration contained in the exhaust supplied no the adsorption device 200 can be further stabilized.

In addition, the plurality of activated carbon cartridges 530 is configured to each be detachable with the housing 520. Since it is thereby possible to replace only an activated carbon cartridge 530 requiring replacement among the plurality of activated carbon cartridges 530, it is easy to perform maintenance of the activated carbon filter device 500.

In addition, the regulatory mechanism 531 that regulates the flow rate of exhaust is provided to the bottom portion of a predetermined activated carbon cartridge 530 among the plurality of activated carbon cartridges 530. It is thereby possible to regulate the released amount of the VOCs adsorbed and retained in the activated carbon cartridges 530 by regulating the regulatory mechanism 531. Consequently, the concentration of VOCs contained in the exhaust supplied to the adsorption device 200 can be further stabilized.

It should be noted that the present invention is not to be limited to the embodiment, and modifications, improvements, and the like within a scope that can achieve the objects of the present invention are included in the present invention.

For example, although two of the filter device main bodies 510 are disposed in the flow path 590 in the present embodiment, it is not limited thereto, and only one of the filter device main bodies 510 may be disposed, or three of more of the filter device main bodies 510 may be disposed therein.

In addition, although the activated carbon cartridges 530 are disposed in a plurality of rows in the width direction of the housing 520 in the present embodiment, it is not limited thereto. Specifically, the length of the activated carbon cartridge in the width direction may be configured to be substantially the same as the length of the housing in the width direction, and this activated carbon cartridge may be disposed to be layered in multiple stages in the height direction of the housing.

In addition, although the activated carbon cartridge 530 of the present invention is applied to the painting facility conducting painting on automobile bodies in the present embodiment, it is not limited thereto. Specifically, the activated carbon cartridges 530 of the present invention may be applied to a painting facility that conducts painting on consumer electrical appliances such as refrigerators and washing machines, and may be applied to a printing facility transcribing ink onto a medium such as paper.

### Damper Device

The damper device will be explained next. It should be noted that, due to the configurations being identical, the first damper device 610 and the second damper device 620 will be explained representing the first damper device 610.

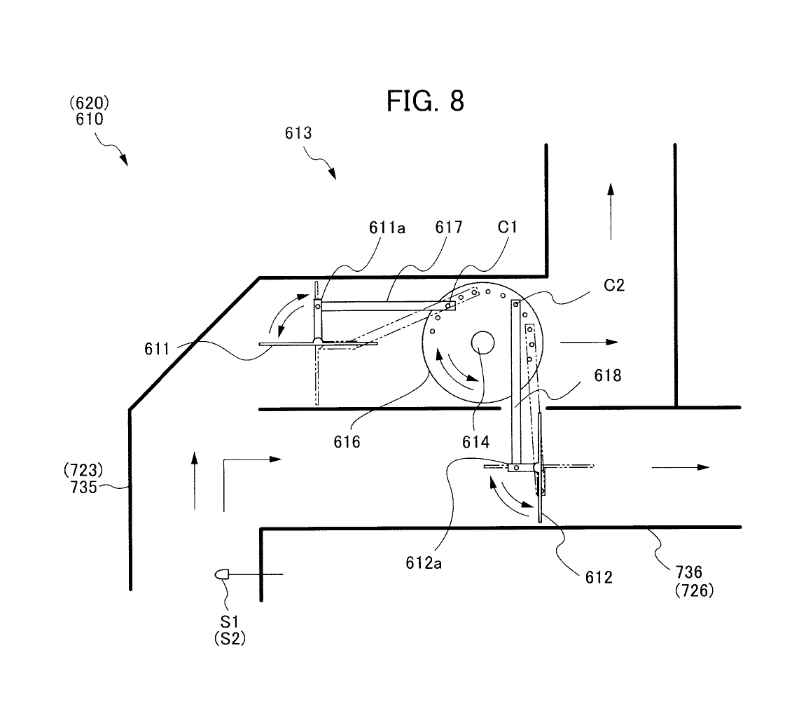

Referring to FIG. 8, the first damper device 610 has an on-off valve 611, an exhaust valve 612, and a switching means 613. The on-off valve 611 opens and closes the flow path of the first main duct 735. The exhaust valve 612 opens and closes the flow path of the first exhaust duct 736. With the switching means 613, when the on-off valve 611 closes the flow path of the first main duct 735, the exhaust valve 612 opens the flow path of the first exhaust duct 736, and when the on-off valve 611 opens the flow path of the first main duct 735, the exhaust valve 612 closes the flow path of the first exhaust duct 736.

Referring to FIG. 1, the switching means 613 operates upon the concentration of VOCs of the purified air discharged from the adsorption device 200 being detected, and operates upon the temperature of the high temperature gas discharged from the regenerative thermal oxidizer 300 being detected. It should be noted that the switching means 613 may operate upon the concentration of VOCs of the purified air discharged from the adsorption device 200 being detected, or operate upon the temperature of the high temperature gas discharged from the regenerative thermal oxidizer 300 being detected.

Referring to FIG. 8, the on-off valve 611 has a first lever crank 611a. When one end of the first lever crank 611a revolves, it is possible to revolve the on-off valve 611. In addition, the exhaust valve 612 has a second lever crank 612a. When one end of the second lever crank 612a revolves, it is possible to revolve the exhaust valve 612.

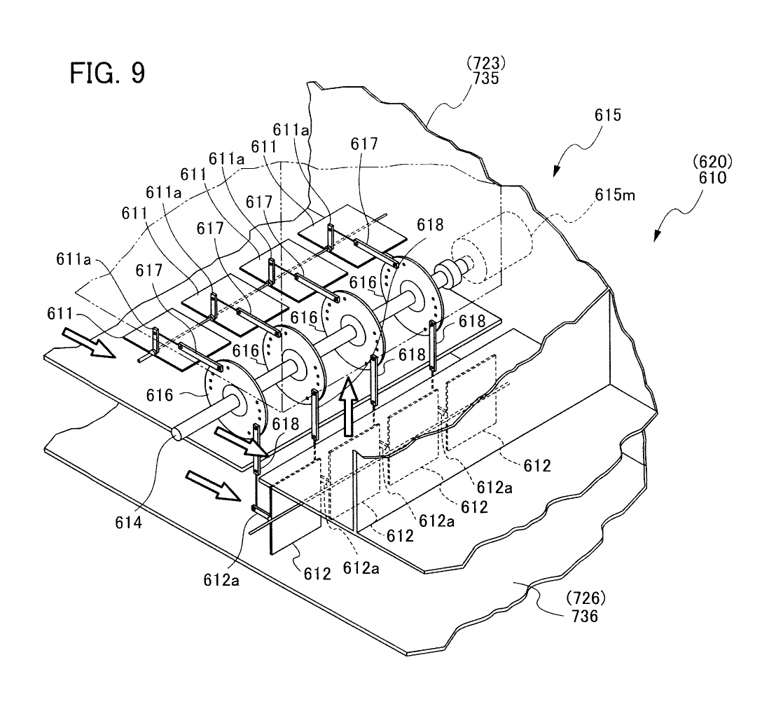

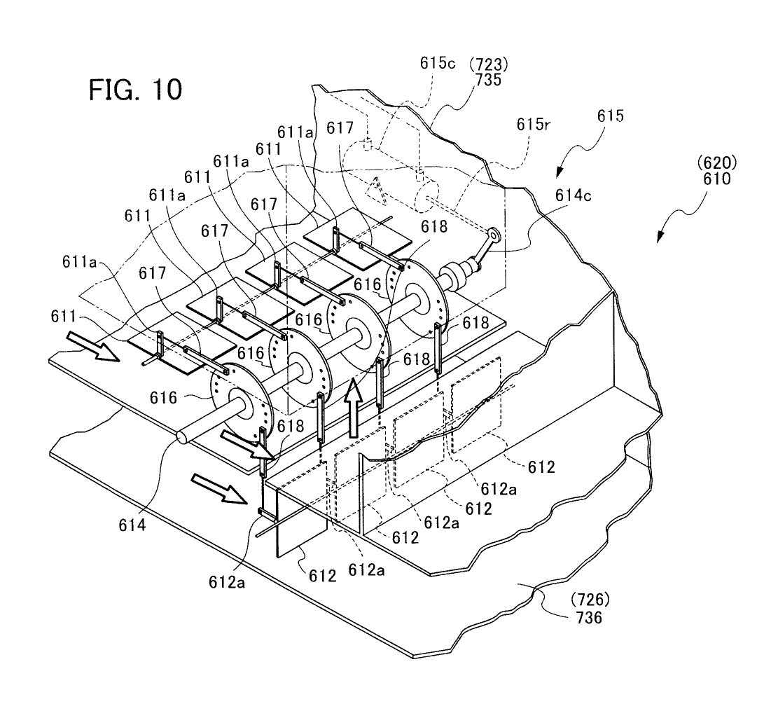

Referring to FIG. 8, the switching means 613 has a revolving shaft 614, a revolving means 615 (refer to FIGS. 9 and 10), pivoting disk 616, first link rod 617, and second link rod 618. The revolving shaft 614 traverses the first main duct 735 in a direction substantially orthogonal to the flow direction of purified air in the first main duct 735 (or high temperature gas in the second main duct 723). The revolving means 615 is disposed outside of the first main duct 735, and causes the revolving shaft 614 to revolve (refer to FIGS. 9 and 10).

Referring to FIG. 8, the pivoting disk 616 is coaxially attached with the revolving shaft 614. In addition, the pivoting disk 616 is provided with rotating connection points C1 and C2 at two points on the circumference, angularly opening to a predetermined angle from the center.

Referring to FIG. 8, the first link rod 617 has one end rotatably connected to one of the rotating connection points C1, and another end rotatably connected to the one end of the first lever crank 611a. The second link rod 618 has one end rotatably connected to the other rotating connection point C2, and another end rotatably connected to the one end of the second lever crank 612a.

Referring to FIG. 8, the first lever crank 611a, first link rod 617, and pivoting disk 616 in the first damper device 610 configure a first lever crank mechanism K1. The first lever crank mechanism K1 establishes a state in which a link (corresponding to the harrier wail of the first main duct 735 in the case of the present embodiment of the invention) paired with the first lever crank 611a, which is the shortest link, is a fixed link. When the first lever crank mechanism K1 undergoes reciprocal angular movement of the pivoting disk 616 to a predetermined angle, the movement is transmitted to the first link rod 617, whereby the first lever crank 611a can be pivoted. In other words, the on-off valve 611 can tilt to a predetermined angle.

In addition, referring to FIG. 8, the second lever crank 612a, second link rod 618, and pivoting disk 616 in the first damper device 610 configure a second lever crank mechanism K2. The second lever crank mechanism K2 establishes a state in which a link (corresponding to a barrier wall of the first main duct 735 in the case of the embodiment of the present invention) paired with the second lever crank 612a, which is the shortest, link, is a fixed link. When the second lever crank mechanism K2 undergoes reciprocal angular movement of the pivoting disk 616 to a predetermined angle, the movement is transmitted to the second link rod 618, whereby the second lever crank 612a can be pivoted. In other words, the on-off valve 612 can tilt to a predetermined aperture.

Referring to FIG. 8, the first lever crank 611a is normally disposed in a direction substantially orthogonal to the flow direction of purified air in the first main duct 735 (or high temperature gas in the second main duct 723), whereby the on-off valve 611 opens the first main duct 735. On the other hand, the second lever crank 612a is disposed in a direction parallel to the flow direction of purified air in the first exhaust duct 736 (or high temperature gas in the second main duct 723), whereby the exhaust valve 612 closes the first exhaust duct 736.

Then, when the pivoting disk 616 revolves to a predetermined angle in one direction, the one end of the first crank lever 611a is pulled by the first link rod 617, whereby the on-off valve 611 can close the first main duct 735. On the other hand, when the pivoting disk 616 revolves to a predetermined angle in one direction, the one end of the second lever crank 612a is pushed by the second link rod 618, whereby the exhaust valve 612 can open the first exhaust duct 736.

In contrast, when the pivoting disk 616 revolves to a predetermined angle in the other direction, the one end of the first lever crank 611a is pushed by the first link rod 617, whereby the valve can open the first main duct 735. On the other hand, when the pivoting disk 616 revolves to a predetermined angle in the other direction, the one end of the second lever crank 612a is pulled by the second link rod 618, whereby the exhaust valve 612 can close the first exhaust duct 736.

Referring to FIG. 8, the pivoting disk 616 is provided with the two rotating connection points C1 and C2 at equal intervals. Since the lengths of the first link rod 617 and second link rod 618 are fixed, the aperture ratio of the exhaust valve 612 can be fine tuned by repositioning the one end of the second link rod 618 to another rotating connection point C2, for example.

Referring to FIGS. 9 and 10, the first damper device 610 separately disposes four of the on-off valves 611, exhaust valves 612, and pivoting disks 616. The first damper device 610 can also be considered as separately disposing four of the first lever crank mechanisms K1 and second lever crank mechanisms K2. Since the first damper device 610 separately disposes the on-off valves 611, exhaust valves 612, and pivoting disks 616, the aperture ratios of the on-off valves 611 and exhaust valves 612 can be more finely tuned.

Referring to FIG. 9, the revolving means 615 is made from a servo motor 615m in which the output shaft connects with one end of the revolving shaft 614.

If a hydraulic servo motor is used as the servo motor 615m, it will be possible to realize a mechanical damper device for which the reliability of the recycling system 130 is ensured. A certain amount of gas is always emitted, and thus disruption of the air balance of the painting zones 111 can be prevented, by angularly controlling the pivoting disks 616 with the servo motor 615m (refer to FIG. 1).

Referring to FIG. 10, the revolving means 615 is made from a positioning air cylinder 615c that can vary the stroke of a piston rod 615r. One end of the revolving shaft 614 has a crank rod 614c that causes the revolving shaft 614 to revolve. Additionally, a leading end of the piston rod 615r, which advances and retracts, connects with a leading end of the crank rod 614c.

With the first damper device 610 in FIG. 10, the stroke of the piston rod 615r is translated into a revolution angle of the pivoting disks 616. A mechanical damper device can be realized by using an air cylinder as the actuator driving the pivoting disks 616. The positioning air cylinder has an advantage in that the stroke of the piston rod can be segmented.

The operation and effects of the damper device will be explained next.

Referring to FIGS. 1 and 8, in normal operation of the painting facility 100, the on-off valve 611 opens the flow path of the first main duct 735 and the second main duct 723, the exhaust valve 612 closes the flow path of the first exhaust duct 736 and the second exhaust duct 726; therefore, the first main duct 735 and the second main duct 723 configure a closed circuit in which purified air and high temperature gas return to the plurality of painting zones 111 and 111.

Referring to FIGS. 1 and 8, the concentration of VOCs in the purified air discharged from the adsorption device 200 is detected by a detector S1, and if a predetermined value or higher, it can be returned to a normal value by the switching means 613 operating, the on-off valve 611 closing the flow path of the first main duct 735, and the exhaust valve 612 opening the flow path of the first exhaust duct 736. It should be noted that the detector S1 is not limited to the location illustrated, and is preferably disposed at a suitable location for the interlock function to operate.

In addition, referring to FIGS. 1 and 8, the temperature of the high temperature gas discharged from the regenerative thermal oxidizer 300 is detected by a detector S2, and if a predetermined value of higher, it can be returned to a normal value by the switching means 613 operating, the on-off valve 611 closing the flow path of the second main duct 723, and the exhaust valve 612 opening the flow path of the second exhaust duct 726. It should be noted that the detector S2 is not limited to the location illustrated, and is preferably disposed at a suitable location for the interlock function to operate.

The damper device according to the embodiment of the present invention has a mechanical interlock function allowing for reverse operations in which, when one damper closes one duct, the other damper opens the other duct, and when on damper opens one duct, the other damper closes the other duct, and thus the reliability of the recycling system 130 is guaranteed.

Referring to FIG. 1, upon causing purified air of the adsorption device 200 to return to the plurality of painting zones 111 and 111 via the air conditioning unit, which is not illustrated, the concentration of VOCs in the purified air is detected, and in a case of being an inappropriate detected value, the first damper device 610 according to the embodiment of the present invention releases this purified air to the atmosphere, and in a case of being an appropriate detected value, sends this purified air to the air conditioning unit. Therefore, a certain level of clean air can always be recycled. In addition, the air balance of the painting zone 111 can be brought to a certain range by controlling the switching means 613 so as to exhaust a certain air volume.

Moreover, referring to FIG. 1, in the second damper device 620 according to the embodiment of the present invention causes the high temperature gas generated by the regenerative thermal oxidizer 300 to return to the plurality of painting zones 111 and 111, the switching means 613 operates upon the temperature of the high temperature gas discharged from the regenerative thermal oxidizer 300 is detected. For example, since the high temperature gas has not reached a predetermined temperature when the regenerative thermal oxidizer 300 is starting up, this high temperature gas is automatically released to the atmosphere. On the other hand, after the point in time when the high temperature gas reached the predetermined temperature, this high temperature gas is recycled by being returned to the plurality of painting zones 111 and 111.

The second damper device 620 according to the embodiment of the present invention in this way can recover heat (thermally recycle) high temperature gas discharged from the regenerative thermal oxidizer 300 at a predetermined temperature.

Referring to FIGS. 8 and 10, the damper device according to the embodiment of the present invention has a mechanical interlock function allowing for reverse operations in which, when one damper closes one duct, the other damper opens the other duct, and when on damper opens one duct, the other damper closes the other duct, and thus a mechanical damper device can be realized in which the reliability of the recycling system 130 is ensured. Compared to an electrically controlled damper device, a mechanical damper device is regarded as generally having fewer malfunctions.

It should be noted that the damper device used in the painting facility of the present invention is not limited to the present embodiment, and modifications, improvements and the like within a scope that can achieved the objects of the present invention are included in the present invention.

### Recycling System

The recycling system 130 will be explained next.

The recycling system 130 recycles purified air having passed through the adsorption device 200 and high temperature gas generated while combusting and removing VOCs with the combustion device 300, by guiding to the painting system 110.

Herein, the recycling system 130 includes a double-tube structure 710 composed of an inner tube 720 through which the high temperature gas recycled by the high temperature gas recycling device flows, and an outer tube 730 that encircles this inner tube 720 with a gap and in which purified air recycled by the purified air recycling device flows in the gap.

The outer tuber 730 is provided so as to encircle the inner tube 720, and the double-tube structure 710 is formed by this outer tube 730 and inner tube 720. The high temperature gas flows to the inner tube 720 via the second main duct 723. The purified air flows to the outer tube 730 via the first main duct 735.

The inner tube 720 is in communication with the regenerative thermal oxidizer 300, and the high temperature gas flows from this regenerative thermal oxidizer 300 in an inner portion 729 of the inner tube 720

On the other hand, the outer tube 730 is a tube in which the first main duct 735 in communication with the adsorption device 200 extends, and purified air having passed through the first main duct 735 flows in the gap 728. Since the high temperature gas is isolated from the open air via the purified air by configuring in this way, rapid cooling of the high temperature gas by the open air (i.e. heavy loss in thermal energy) is suppressed, and also the purified air is raised in temperature by the thermal energy lost from the high temperature gas. It should be noted that, in so far as being equipped with the double-tube structure 710, a configuration equipped with more tubular bodies is not excluded. For example, a third tube may be disposed between the inner tube 720 and the outer tube 730, or outside of the outer tube 730.

The installation area of the double-tube structure 710 is not particularly limited, and may be appropriately set according to the positional relationship of the adsorption device 200 and the regenerative thermal oxidizer 300. The double-tube structure 710 of the present embodiment is provided until immediately before the recycling system control device 800 described later, whereby temperature declines in the high temperature gas and purified air are suppressed to the fullest. In addition, the double-tube structure 710 is provided from the vicinity of the regenerative thermal oxidizer 300 to a downstream side so as to be able to suppress a temperature decline in the high temperature gas by shortening the length of the second main duct 723.

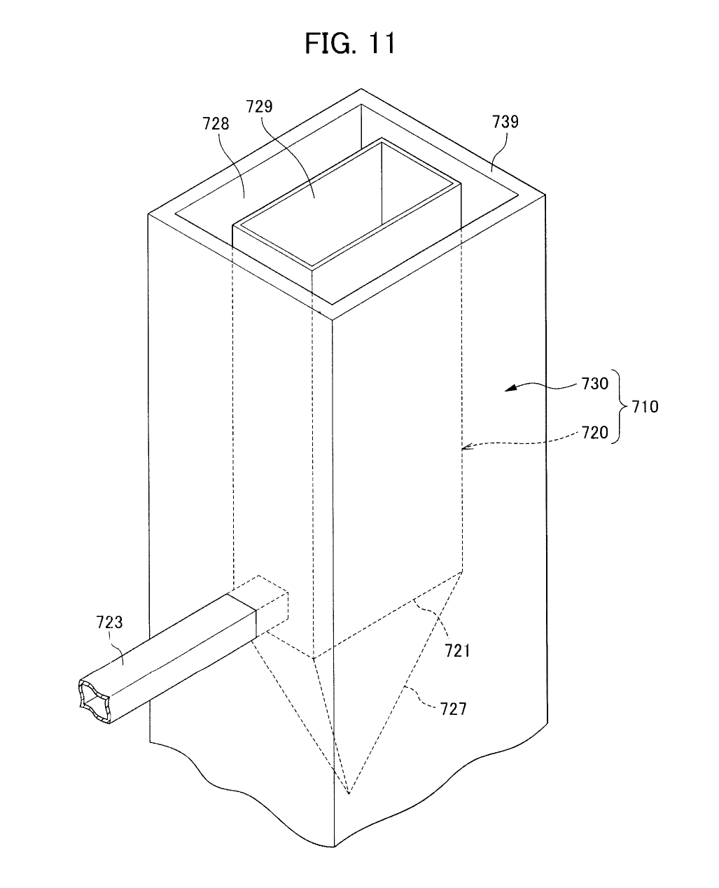

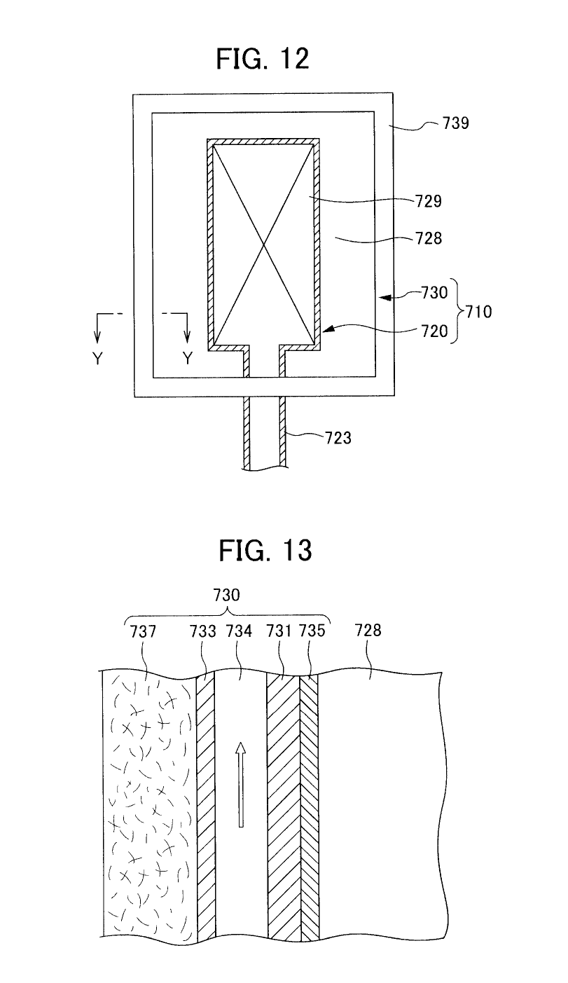

FIG. 11 is an overall perspective view of the double-tube structure 710 of FIG. 1, and FIG. 12 is a plan view of FIG. 11. In the present embodiment, the inner portion 729 of the inner tube 720 is in communication with the regenerative thermal oxidizer 300 via the second main duct 723 as a communication tube that penetrates the outer tube 730 as shown in FIG. 11, whereby high temperature gas is supplied to the inner portion 729 through the second main duct 723. Then, since the second main duct 723 is disposed so as to penetrate the outer tube 730 in the relative vicinity of the regenerative thermal oxidizer 300 as shown in FIG. 1, cooling of the high temperature gas by open air while flowing through the second main duct 723 can be suppressed to a minimum. It should be noted that the structure that allows the inner tube 720 to be in communication with the regenerative thermal oxidizer 300 is not limited thereto, and it may be a structure in which the inner tube is extended to a base end of the outer tube, and is further extended from the base end of the outer tube to the regenerative thermal oxidizer 300, for example.

A taper portion 722 that reduced in diameter towards a counterflow direction of the purified air (upstream side of the outer tube 730) is provided to a base end 721 of the inner tube 720 of the present embodiment. Impinging of the purified air that has flowed from the upstream side with the base end 721 is thereby mitigated, and the flow of purified air is smoothed. It should be noted that the taper portion 722 may be integrated with the inner tube 720, or may be a separate body, and the inner portion of the taper portion 722 may be in communication with the inner portion 729 of the inner tube 720, or may not be in communication therewith.

In addition, although the taper portion 722 is provided to the base end 721 in the present embodiment, a taper portion that reduces in diameter towards the counterflow direction of the purified air may be provided at a portion of the second main duct 723 that penetrates into the outer tube 730. The flow of the purified air is thereby smoothed. It should be noted that, although the taper portion 722 in the present embodiment is a square pyramid shape, it may be any form so long as reducing in diameter toward the counterflow direction of the purified air. In addition, the space in which the purified air is allowed to flow may be adequately ensured, and the flow of purified air smoothed by carrying out design modifications to increase the inside diameter of the outer tube 730 at the installation position of the double-tube structure 710.

In the present embodiment, the first damper device 610 is provided in the middle of the first main duct 735, specifically more on an upstream side than the taper portion 722, and the purified air from the adsorption device 200 flows inside the outer tube 730 or is discharged to open air from the first exhaust duct 736, depending on the opening and closing of this first damper device 610. Similarly, the second damper device 620 is provided in the middle of the second main duct 723, and the gas from the regenerative thermal oxidizer 300 is supplied to the inner portion 729, or released to the open air from the second exhaust duct 726, depending on the opening and closing of this second damper device 620. An accident can thereby be prevented by releasing to the open air when some abnormality arises in the high temperature gas and purified air. For example, in a case of the pyrolysis treatment temperature in the regenerative thermal oxidizer 300 not having reached a certain temperature such as during startup of the regenerative thermal oxidizer 300, since the removal of VOCs by the VOC removal system 120 is not adequately performed, the first damper device 610 and the second damper device 620 open to atmospherically release the purified air and high temperature gas and not execute recycling.

FIG. 13 is a cross-sectional view along the line Y-Y in FIG. 12. As shown in FIG. 13, the outer tube 730 of the present embodiment has a tube-shaped first insulating member 731 disposed on an inner side (provided to the circumference of the first main duct 735 in the present embodiment), a tube-shaped second insulating member 733 disposed on an outer side, and a void 734 interposing between the first insulating member 731 and the second insulating member 733 and extending along the axial direction of the outer tube 730 (up-down direction in FIG. 13). This void 734 is in communication with the regenerative thermal oxidizer 300 via the supply tube 738 serving as a supply means, and the supply tube 738 supplies high temperature gas from the regenerative thermal oxidizer 300 to the void 734. Cooling of the purified air by the open air is thereby suppressed as a result of the purified air flowing in the gap 728 being isolated from the open air. In addition, since the high temperature gas flowing in the void 734 is sandwiched between the first insulating member 731 and the second insulating member 733, a temperature decline in the purified air and a temperature decline in the high temperature gas in the inner portion 729 accompanying this can be effectively suppressed. It should be noted that the high temperature as flowing in the void 734 is before long released from a terminal end 739 of the void 734 to the open air.

The length of the supply tube 738 is shortened to be provided from the vicinity of the regenerative thermal oxidizer 300 to a downstream side, so as to be able to suppress cooling of the high temperature gas supplied to the void 734. Consequently, since the supply tube 738 is provided to the void 734 on an upstream side in the present embodiment, the high temperature gas flowing in the void 734 flows in the same direction as the purified air; however, it is not limited thereto. In addition, although the void 734 is formed at the entire circumference of the first insulating member 731, it is not limited thereto, and may be formed at only a portion of the circumference.

In the present embodiment, a third insulating member 737 is provided at the outer circumference of the second insulating member 733, whereby a temperature decline in the high temperature gas flowing in the void 734 is further suppressed. It should be noted that, although the first insulating member 731 and second insulating member 733 of the present embodiment are configured by an aluminum insulating sheet, the first main duct 735 is configured by Alutite steel plate, and the third insulating member 737 is configured by rock wool, they are not limited thereto.

By configuring in this way, purified air that has flowed through the gap 728 and high temperature gas that has flowed through the inner portion 729 are introduced to the recycling system control device 800. Then, these oases are mixed with fresh air introduced from the air damper device 810, and warmed up to a desired temperature by a gas burner 840 as necessary, then guided to the painting system 110, thereby being recycled.

Herein, the recycling system control device 800 controls the amount of recycled, gas (purified air and high temperature gas) recycled by the recycling system 130, and specifically, controls the amount of fresh it amount of purified air and amount of high temperature gas supplied to the painting system 110 by regulating the aperture of the air damper device 810 based on the high temperature gas concentration detected by a CO₂ sensor 820 serving as a high temperature gas concentration sensor to cause the internal pressure of the recycling system control device 800 to change. Since the amount of recycled gas (purified air and high temperature gas) can be controlled according to the high temperature gas concentration in the recycled gas (purified air and high temperature gas), safe and stable recycling operation of the painting facility 100 additionally becomes possible.

The following effects are exerted according to the above recycling system 130.

The high temperature gas flows through the inner portion 729 of the inner tube 720; whereas, the purified gas flows through the gap 728 between the inner tube 720 and the outer tube 730. Since the high temperature gas is thereby isolated via the purified air from the open air, rapid cooling of the high temperature gas by the open air (i.e. heavy loss in thermal energy) is suppressed, and also the purified air is raised in temperature by the thermal energy lost from the high temperature gas. Consequently, the purified air and high temperature gas can be efficiently recycled.

Since the inner tube 720 is made to be in communication with the regenerative thermal oxidizer 300 via the second main duct 723 penetrating the outer tube 730, the second main duct 723 can be designed to be comparatively shorter, irrespective of the positional relationship between the regenerative thermal oxidizer 300 and the adsorption device 200. A temperature decline in the high temperature gas is thereby suppressed, and thus the purified air and the high temperature gas can be more efficiently recycled.

Since the taper portion 722 is provided to the base end 721 of the inner tube 720, impinging of the purified air that has flowed from the upstream side with the base end 721 is mitigated. Flow of the purified air is thereby smoothed without performing special design modifications; therefore, recycling of the purified air can be made more efficient.

Since the high temperature gas is supplied to the void 734, which extends along the axial, direction of the outer tube 730, i.e. the flow direction of purified air, the purified air is isolated from the open air, a result of which cooling of the purified air by the open air is suppressed. In addition, since the void 734 is formed so as to interpose between the first insulating member 731 and the second insulating member 733; therefore, a temperature decline in the high temperature gas flowing in the void 734 is suppressed. A temperature decline in the purified air and a temperature decline in the high temperature gas in the inner portion 729 accompanying this can thereby be effectively suppressed; therefore, recycling of the purified air and the high temperature gas can be made more efficient.

It should be noted that the present invention is not to be limited to the embodiment, and modifications, improvements, and the like within a scope that can achieve the objects of the present invention are included in the present invention.

### Recycling System Control Device

The recycling system control device 800 will be described next.

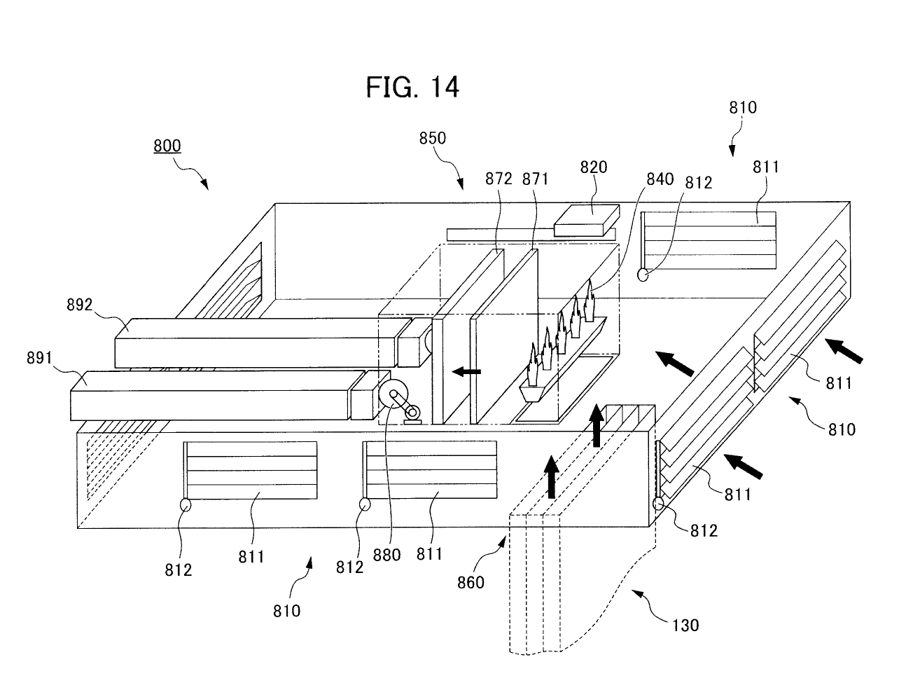

FIG. 14 is a diagram showing the configuration of the recycling system control device 800.

The recycling system control, device 800 controls the amount of recycled gas (purified air and high temperature gas) by way of the recycling system 130, as described above.

The recycling system control device 800 includes a static pressure regulated chamber 850 having a feed port 860 that introduces purified air recycled by the aforementioned recycling system 130, an air damper device 810 as a fresh air supply mechanism that supplies fresh air to the painting system 110, a CO₂ sensor 820 as a high temperature gas concentration sensor that measures the concentration of high temperature as in the static pressure regulated chamber 850, and an ECU 830 (not illustrated) as a recycle control mechanism that controls the amount of fresh air supplied to the painting system 110, and the amount of purified air and the amount of high temperature gas recycled, by causing the fresh air supply mechanism to be driven based on the concentration of high temperature gas measured by this CO₂ sensor 820 to adjust the pressure inside the static pressure regulated chamber 850.

The air damper device 810 includes a motor 812 and a plurality of multi-vane dampers 811 for which adjustment of the aperture is possible by this motor 812.

The aperture of the multi-vane dampers 811 is adjusted according to a control signal from the ECU 830. The ECU 830 is connected with the CO₂ sensor 820, and the detection signal of the CO₂ sensor 820 is supplied to the ECU 830. The ECU 830 includes an input circuit having functions such as smoothing the input, signal waveform from the CO₂ sensor 820, adjusting the voltage level no a predetermined level, and converting analog signal values to digital signal values, and a central processing unit (hereinafter referred to as CPU). Additionally, the ECU 830 includes a storage circuit that stores various operating programs executed by the CPU, computational results, and the like, and an output circuit that outputs control signals to the air damper device 810.

In addition, included in the static pressure regulated chamber 850 are a gas burner 840 that warms the fresh air and purified air introduced thereto, wall filters 871 and 872, an air supply fan 880 for guiding air to the painting system 110, and air supply channels 891 and 892.

Operation of the above recycling system control, device 800 will be explained.

First, purified air is introduced into the static pressure regulated chamber 850 from the feed port 860 by the aforementioned recycling system 130. The concentration of high temperature gas in the static pressure regulated chamber 850 is detected by the CO₂ sensor 820, and the detection signal thereof is supplied to the ECU 830. Next, the control signal from the ECU 830 is output to the air damper device 810, and the aperture of the multi-vane damper 811 is adjusted based on the concentration of high temperature gas thus detected.

Since a large amount of fresh air is introduced into the static pressure regulated chamber 850 and the negative pressure inside the static pressure regulated chamber 850 becomes low when the multi-vane damper 811 is fully open, the amount of purified air recycled by the recycling system 130 decreases greatly. Conversely, since the negative pressure inside the static pressure regulated chamber 850 becomes high when the multi-vane damper 811 is fully closed, a 100% recycle state is entered.

As a result, when the concentration of high temperature gas detected by the CO₂ sensor 820 exceeds a set value, the negative pressure inside the static pressure regulated chamber 850 reduces by the aperture of the multi-vane damper 811 increasing to cause the amount of fresh introduced to increase, whereby the amount of purified air and the amount of high temperature gas recycled can be made to decrease. On the other hand, when the concentration of the high temperature gas detected by the CO₂ sensor 820 is less than the set value, the negative pressure inside the static pressure regulated chamber 850 increases by the aperture of the multi-vane damper 811 reducing to cause the amount of fresh air introduced to decrease, whereby the amount of purified air and the amount of high temperature gas recycled can be made to increase.

The fresh air introduced from the air damper device 810 and the purified air introduced from the feed port 860 are mixed inside the static pressure regulated chamber 850, and warmed by the gas burner 840. After the air warmed by the gas burner 840 passes through the wall filters 871 and 872, it is guided through the air supply channels 891 and 892 by the air supply fan 880 to the painting system 110.

The following effects are exerted according to the above recycling system control device 800.

The recycling system control device 800 of the painting equipment 100, which is able to purify exhaust (VOCs) generated by painting and recycle, is configured by the static pressure regulated chamber 850 having a feed port 860 which introduces purified air recycled by the recycling system 130, a fresh air supply mechanism that supplies fresh air to the painting system 110, the CO₂ sensor 820 as a high temperature gas concentration sensor that measures the concentration of the high temperature gas in the static pressure regulated chamber 850, and a recycle control mechanism that controls the amount of fresh air supplied to the painting system, and the amount of purified air and the amount of high temperature gas recycled, by causing the fresh air supply mechanism to be driven to adjust the pressure inside the static pressure regulated chamber 850, based on the concentration of the high temperature gas measured by the CO₂ sensor 820.

It has thereby become possible in the painting facility 100, which is able to purify exhaust (VOCs) generated by painting and to recycle, to control the amount of recycled gas (purified air and high temperature gas) depending on the concentration of the high temperature gas in the static pressure regulated chamber 850. Furthermore, safe and stable recycling operation of the painting facility 100 has been made possible.

In addition, the fresh air supply mechanism is configured by the air damper device 810 for which adjustment of the aperture is possible. The aperture of the air damper device 810 is adjusted based on the concentration of the high temperature as measured by the CO₂ sensor, whereby it is made possible to easily and reliably control the amount of fresh air supplied to the painting system 110 and the amount of purified air and the amount of high temperature as recycled.

It should be noted that the present invention is not to be limited to the embodiment, and modifications, improvements, and the like within a scope that can achieve the objects of the present invention are included in the present invention.

For example, although the multi-vane damper 811 is used in the present embodiment as the air damper device 810, which corresponds to the fresh air supply mechanism, a rotary damper or the like may be used. In addition, although the present invention has been applied to the painting facility 100, which conducts painting on the bodies of automobiles, in the present embodiment, it is not limited thereto.

Specifically, the present invention may be applied to a painting facility that conducts painting on consumer electrical appliances such as refrigerators and washing machines, and may be applied to printing equipment transcribing ink onto a medium such as paper.

1. An exhaust recycling system, comprising:
a predetermined zone that discharges exhaust containing volatile organic compounds;
an adsorption device that adsorbs volatile organic compounds in the exhaust discharged from the predetermined zone; and
a purified air recycling device that causes the volatile organic compounds adsorbed to the adsorption device to desorb from the adsorption device to be a combustible fuel for a combustion device, and guides purified air purified by passing through the adsorption device to the predetermined zone again.

2. The exhaust recycling system according to claim 1,
wherein the adsorption device includes an adsorption portion that adsorbs volatile organic compounds, a desorption portion that causes the volatile organic compounds thus adsorbed to desorb, and a switching mechanism that can switch between the adsorption portion and the desorption portion, and
wherein the purified air recycling device causes volatile organic compounds adsorbed to the adsorption device to desorb by supplying high temperature gas generated while combustively removing volatile organic compounds in the combustion device to the desorption portion.

3. The exhaust recycling system according to claim 1, wherein the exhaust recycling system further comprises a high temperature gas recycling device that recycles high temperature gas generated while combustively removing volatile organic compounds in the combustion device by guiding the high temperature gas to the predetermined zone.

4. The exhaust recycling system according to claim 3,
wherein the purified air recycling device includes:
a first main duct for recycling the purified air by guiding to the predetermined zone;
a first exhaust duct for releasing the purified air to the atmosphere that branches from the first main duct; and
a first damper device that is provided at a branching portion of the first main duct and the first exhaust duct, and has a first valve switching device.

5. The exhaust recycling system according to claim 4,
wherein the first valve switching device contains an on-off valve that opens and closes a flow path of the first main duct, an exhaust valve that opens and closes a flow path of the first exhaust duct, and a switching means for opening the flow path of the first exhaust duct by the exhaust valve when the on-off valve closes the flow path of the first main duct, and for closing the flow path of the first exhaust duct by the exhaust valve when the on-off valve opens the flow path of the first main duct,
wherein the switching means operates upon a concentration of volatile organic compounds in the purified air being detected, and operates upon a temperature of the high temperature gas discharged from the combustion device being detected.

6. The exhaust recycling system according to claim 3,
wherein the high temperature gas recycling device includes:
a second main duct for recycling the high temperature gas by guiding to the predetermined zone;
a second exhaust duct for atmospherically releasing the high temperature gas that branches from the second main duct; and
a second damper device that is provided at a branching portion of the second main duct and the second exhaust duct, and has a second valve switching device.

7. The exhaust recycling system according to claim 6,
wherein the second valve switching device has an on-off valve that opens and closes a flow path of the second main duct, an exhaust valve that opens and closes a flow path of the second exhaust duct, and a switching means for opening the flow path of the second exhaust duct by the exhaust valve when the on-off valve closes the flow path of the second main duct, and for closing the flow path of the second exhaust duct by the exhaust valve when the on-off valve opens the flow path of the second main duct,
wherein the switching means operates upon a concentration of volatile organic compounds in the purified air being detected, and operates upon a temperature of the high temperature gas discharged from the combustion device being detected.

8. The exhaust recycling system according to claim 3, wherein the exhaust recycling system has a double-tube structure composed of an inner tube in which high temperature gas recycled by the high temperature gas recycling device flows, and an outer tube that encircles the inner tube with a gap therebetween and in which purified air recycled by the purified air recycling device flows in the gap.

9. An exhaust recycling system according to claim 3, the exhaust recycling system comprising an exhaust recycling system control device,
wherein the exhaust recycling system control device includes:
a static pressure regulated chamber into which the purified air and the high temperature gas are introduced;
a fresh air supply mechanism that is provided to the static pressure regulated chamber and supplies fresh air to the predetermined zone;
a high-temperature gas concentration sensor that is provided to the static pressure regulated chamber and measures a concentration of the high temperature gas in the static pressure regulated chamber; and
an exhaust recycle control mechanism that controls an amount of fresh air supplied to the predetermined zone and an amount of purified air recycled, by causing the fresh air supply mechanism to be driven to regulate pressure inside the static pressure regulated chamber, based on the concentration of the high temperature gas measured by the high-temperature gas concentration sensor.

10. An activated carbon filter device having a filter device main body through which exhaust discharged from a predetermined zone in which volatile organic compounds are generated flows,
wherein the filter device main body comprises
an activated carbon cartridge having a function of adsorbing and retaining a portion of volatile organic compounds contained in exhaust discharged from the predetermined zone, and of releasing a portion of the volatile organic compounds adsorbed and retained, in a case of a concentration of the volatile organic compounds contained in the exhaust being low.

11. The activated carbon filter device according to claim 10,
wherein the filter device main body further comprises a housing disposed in a flow path of exhaust discharged from the predetermined zone,
wherein the activated carbon cartridges are disposed to be layered in multiple stages inside of the housing with a predetermined gap in a height direction therebetween, and
wherein a plurality of partition plates sloped downward toward a flow direction of the exhaust is each disposed between two of the activated carbon cartridges that are adjoining.

12. The activated carbon filter device according to claim 10, wherein a regulatory mechanism that regulates a flow rate of the exhaust is provided to a bottom portion of a plurality of the activated carbon cartridges.

13. The activated carbon filter device according to claim 11,
wherein the housing includes:
a first main body portion disposed substantially perpendicular to an introduction direction of the exhaust at a central portion in the width direction of the flow path;
a pair of second main body portions that extends from both ends in the width direction of the first main body portion to a downstream side, and is disposed substantially perpendicular to the first main body portion; and
a pair of third main body portions that extends outwards from a leading end of each of the pair of second main body portions, and is disposed substantially perpendicular to each of the pair of second main body portions.

14. The activated carbon filter device according to claim 11, wherein the filter device main body is disposed in plurality with a predetermined gap.

15. The activated carbon filter device according to claim 11, wherein a plurality of the activated carbon cartridges is configured to be detachable with the housing.
